(19) United States
(12) Patent Application Publication
(10) Pub. No.: US 2024/0364746 A1
(43) Pub. Date: Oct. 31, 2024

(54) SYSTEM AND METHOD FOR ENFORCING SERVICE CONTROL POLICIES FOR SERVICES AND SERVICE FEATURES

(71) Applicant: ORACLE INTERNATIONAL CORPORATION, Redwood Shores, CA (US)

(72) Inventors: Mihai Prica, Redmond, WA (US); Richard Stockton, Minneapolis, MN (US); Prabhjot Singh, Monroe, WA (US)

(21) Appl. No.: 18/639,811

(22) Filed: Apr. 18, 2024

Related U.S. Application Data
(60) Provisional application No. 63/462,868, filed on Apr. 28, 2023.

(51) Int. Cl. H04L 9/40

(52) U.S. Cl. CPC H04L 63/20

(57) ABSTRACT

Embodiments described herein are generally related to systems and methods for providing cloud environments, for use by tenants of a cloud infrastructure environment in accessing software products, services, or other offerings associated with the environment, including methods for defining and enforcing service control policies directed to services and service features. In accordance with an embodiment, the system comprises a service control repository or service catalog that provides a definition of the services and service features, together with service control policies or rules that define availability or access to the service features. A service control policy framework, comprising a feature management service, determines, by reference to a hierarchy of entities defining the service control policies, which different entities can control the availability of particular services or service features to end users.

### CLAIM OF PRIORITY AND CROSS-REFERENCE TO RELATED APPLICATIONS

This application claims the benefit of priority to U.S. Provisional Patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,868, filed Apr. 28, 2023; and is related to U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,875, filed Apr. 28, 2023; U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,878, filed Apr. 28, 2023; U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,880, filed Apr. 28, 2023; U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,882, filed Apr. 28, 2023; and U.S. Provisional patent application titled “SYSTEM AND METHOD FOR PROVIDING DEDICATED CLOUD ENVIRONMENTS FOR USE WITH A CLOUD COMPUTING INFRASTRUCTURE”, Application No. 63/462,885, filed Apr. 28, 2023; each of which above applications and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to systems and methods for providing cloud environments, for use by tenants of a cloud infrastructure environment in accessing software products, services, or other offerings associated with the environment, including methods for defining and enforcing service control policies directed to services and service features.

### BACKGROUND

A cloud computing environment can be used to provide access to a range of complementary cloud-based components, such as software applications or services, that enable organizations or enterprise customers to operate their applications and services in a highly-available hosted environment.

The benefits to an organization in moving their application and service needs to a cloud environment include a reduction in the cost and complexity of designing, building, operating, and maintaining their own on-premise data center, software application framework, or other information technology infrastructure; allowing them to instead focus on managing their day-to-day business.

### SUMMARY

Embodiments described herein are generally related to systems and methods for providing cloud environments, for use by tenants of a cloud infrastructure environment in accessing software products, services, or other offerings associated with the environment, including methods for defining and enforcing service control policies directed to services and service features.

In accordance with an embodiment, the system comprises a service control repository or service catalog that provides a definition of the services and service features, together with service control policies or rules that define availability or access to the service features. A service control policy framework, comprising a feature management service, determines, by reference to a hierarchy of entities defining the service control policies, which different entities can control the availability of particular services or service features to end users.

In accordance with an embodiment, a service control policy can be controlled by a hierarchy of entities or at multiple levels. At each level within the hierarchy, only the service features that have been made available by a higher-level entity can be controlled by a service control policy at that level.

### BRIEF DESCRIPTION OF THE DRAWINGS

FIG. 1 illustrates a system for providing a cloud infrastructure environment, in accordance with an embodiment.

FIG. 2 further illustrates how a cloud infrastructure environment can be used to provide cloud-based applications or services or services, in accordance with an embodiment.

FIG. 3 illustrates an example cloud infrastructure architecture, in accordance with an embodiment.

FIG. 4 illustrates another example of a cloud infrastructure architecture, in accordance with an embodiment.

FIG. 5 illustrates another example of a cloud infrastructure architecture, in accordance with an embodiment.

FIG. 6 illustrates another example of a cloud infrastructure architecture, in accordance with an embodiment.

FIG. 7 illustrates a system that provides dedicated or private label cloud environments, for use by tenants or customers of a cloud infrastructure environment, in accordance with an embodiment.

FIG. 8 further illustrates the use of cloud realms, for use by tenants or customers of a cloud infrastructure environment, in accordance with an embodiment.

FIG. 9 further illustrates the use of cloud realms, for use by tenants or customers of a cloud infrastructure environment, in accordance with an embodiment.

FIG. 10 illustrates a system for providing access to software products or services in a cloud computing or other computing environment, in accordance with an embodiment.

FIG. 11 illustrates an example cloud infrastructure environment that can use service control policies, in accordance with an embodiment.

FIG. 12 illustrates how services or service features can be enabled or disabled according to a hierarchy of entities defining the service control policies, in accordance with an embodiment.

FIG. 13 further illustrates how services or service features can be enabled or disabled according to a hierarchy of entities defining the service control policies, in accordance with an embodiment.

FIG. 14 illustrates a process for use with service control policies to enable or disable availability or access to services or service features, in accordance with an embodiment.

FIG. 15 illustrates another process for use with service control policies to enable or disable availability or access to service features, in accordance with an embodiment.

FIG. 16 illustrates another process for use with service control policies to enable or disable availability or access to service features, in accordance with an embodiment.

FIG. 17 illustrates how a hierarchy of entities defining the service control policies can be used to indicate services or service features as enabled, disabled, deprecated, or retired, in accordance with an embodiment.

FIG. 18 illustrates an example use of service control policies within a cloud infrastructure environment, in accordance with an embodiment.

FIG. 19 further illustrates an example use of service control policies within a cloud infrastructure environment, in accordance with an embodiment.

FIG. 20 further illustrates an example use of service control policies within a cloud infrastructure environment, in accordance with an embodiment.

FIG. 21 further illustrates an example use of service control policies within a cloud infrastructure environment, in accordance with an embodiment.

FIG. 22 illustrates a process of using service control policies to enable or disable availability or access to service features, from a perspective of a client device or console, in accordance with an embodiment.

FIG. 23 illustrates a process of using service control policies to enable or disable availability or access to service features, from a perspective of a service platform, in accordance with an embodiment.

FIG. 24 illustrates a process of using service control policies to enable or disable availability or access to service features, from a perspective of a feature management service, in accordance with an embodiment.

FIG. 25 illustrates an example user interface for managing the use of service control policies within a cloud infrastructure environment, in accordance with an embodiment.

FIG. 26 further illustrates an example user interface for managing the use of service control policies within a cloud infrastructure environment, in accordance with an embodiment.

FIG. 27 further illustrates an example user interface for managing the use of service control policies within a cloud infrastructure environment, in accordance with an embodiment.

### DETAILED DESCRIPTION

A cloud computing or cloud infrastructure environment can be used to provide access to a range of complementary cloud-based components, such as software applications or services, which enable organizations or enterprise customers to operate their applications and services in a highly-available hosted environment.

The benefits to an organization in moving their application and service needs to a cloud infrastructure environment include a reduction in the cost and complexity of designing, building, operating, and maintaining their own on-premise data center, software application framework, or other information technology infrastructure; allowing them to instead focus on managing their day-to-day business.

### Cloud Infrastructure Environments

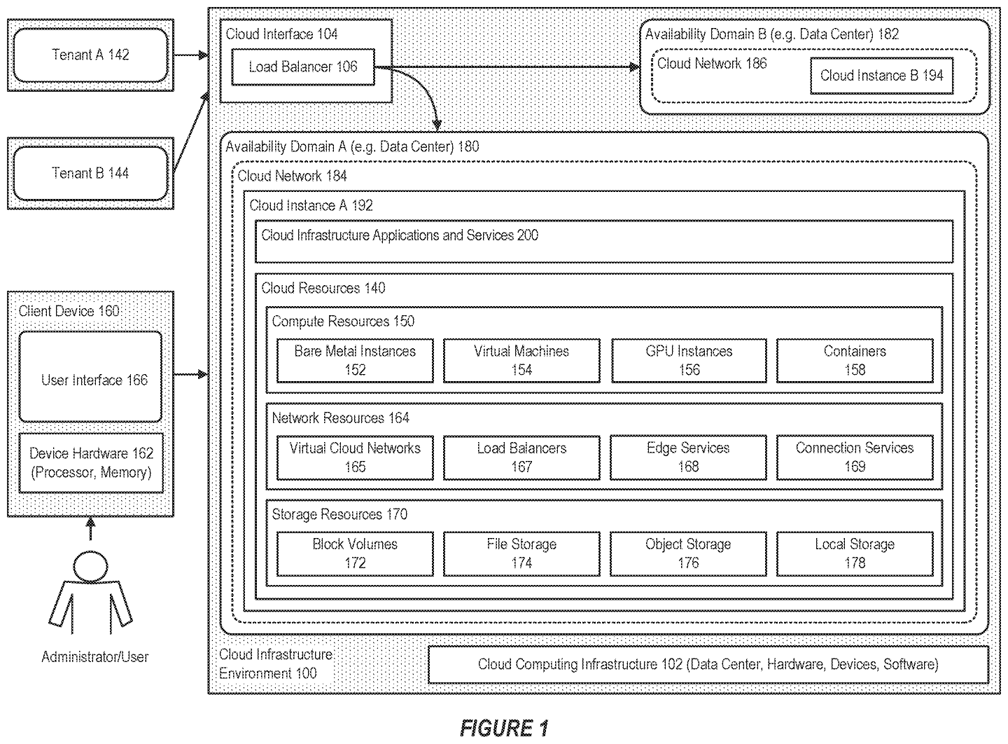

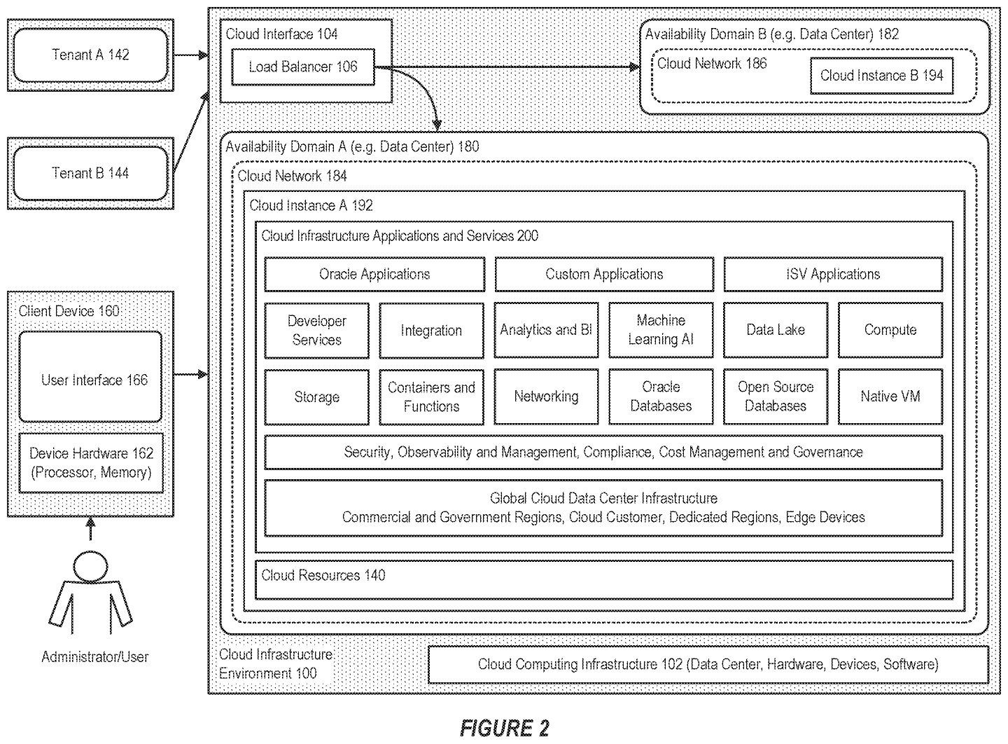

FIGS. 1 and 2 illustrate a system for providing a cloud infrastructure environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers 106.

In accordance with an embodiment, the cloud infrastructure environment supports the use of availability domains, such as, for example, availability domains A 180, B 182, which enables customers to create and access cloud networks 184, 186, and run cloud instances A 192, B 194.

In accordance with an embodiment, a tenancy can be created for each cloud tenant/customer, for example tenant A 142, B 144, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 160 having a device hardware 162 (e.g., processor, memory), and graphical user interface 166, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 140 via, for example, a compute resources layer 150, a network resources layer 164, and/or a storage resources layer 170. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 152, virtual machines 154, graphical processing unit (GPU) compute cloud instances 156, and/or containers 158. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 165, load balancers 167, edge services 168, and/or connection services 169.

In accordance with an embodiment, the storage resources layer can comprise a number of resources, such as, for example, data/block volumes 172, file storage 174, object storage 176, and/or local storage 178.

As illustrated in FIG. 2, in accordance with an embodiment, the cloud infrastructure environment can include a range of complementary cloud-based components, for example as cloud infrastructure applications and services 200, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

For example, in accordance with an embodiment, such an environment can include racks physically and managed by a cloud infrastructure provider; customer's racks; access for cloud operations personnel for setup and hardware support; customer's data center power and cooling; customer's floor space; an area for customer's data center personnel; and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's public cloud regions, such as, for example, ERP, Financials, HCM, and SCM. A customer can seamlessly lift and shift legacy workloads using the cloud infrastructure provider's services, for example bare metal compute, VMs, and GPUs; database services, for example Autonomous Database; or container-based services, for example Container Engine for Kubernetes.

In accordance with an embodiment, a cloud infrastructure environment can operate according to infrastructure-as-a-service (IaaS) model that enables the environment to provide virtualized computing resources over a public network (e.g., the Internet).

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components (example services include billing software, monitoring software, logging software, load balancing software, or clustering software). Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not be, a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries, or daemons). This is often managed by the cloud infrastructure provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In accordance with an embodiment, IaaS provisioning may refer to acquiring computers or virtual hosts for use, and even installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

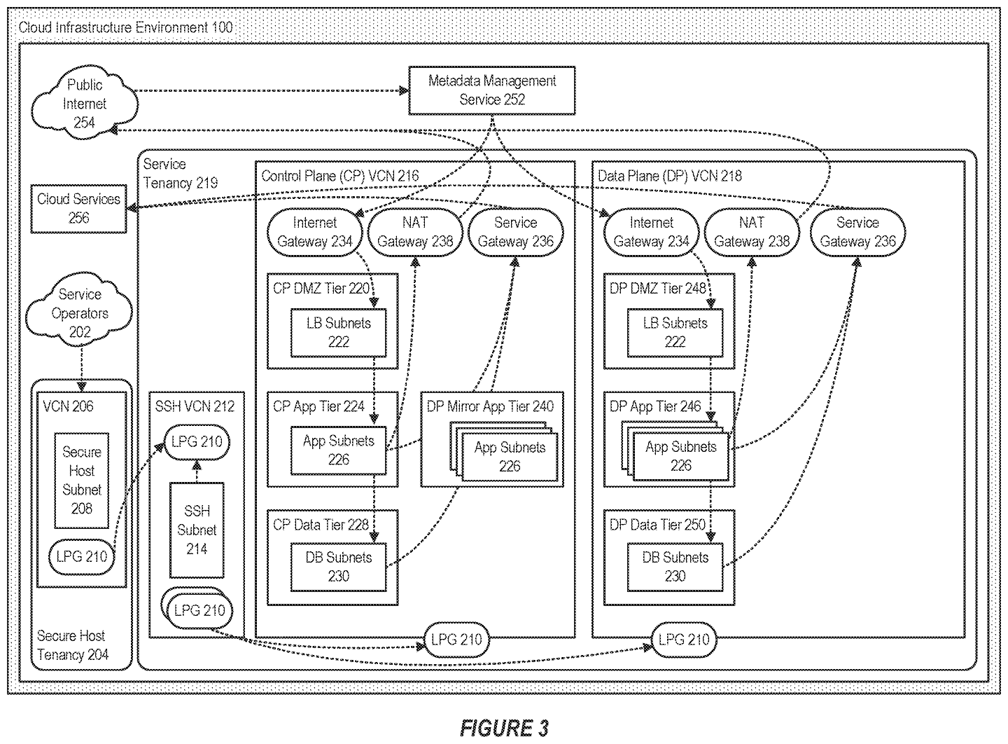

FIG. 3 illustrates an example cloud infrastructure architecture, in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices, which may be portable handheld devices (e.g., a telephone, a computing tablet, a personal digital assistant (PDA)) or wearable devices (e.g., a head mounted display), running software such as Microsoft Windows, and/or a variety of mobile operating systems such as IOS, Android, and the like, and being Internet, e-mail, short message service (SMS), or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Chrome. Alternatively, or in addition, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnet(s) 222, a control plane app tier 224 that can include app subnet(s) 226, and a control plane data tier 228 that can include database (DB) subnet(s) 230 (e.g., frontend DB subnet(s) and/or backend DB subnet(s)). The LB subnet(s) contained in the control plane DMZ tier can be communicatively coupled to the app subnet(s) contained in the control plane app tier, and an Internet gateway 234 that can be contained in the control plane VCN, and the app subnet(s) can be communicatively coupled to the DB subnet(s) contained in the control plane data tier and a service gateway 236 and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier 246, a data plane DMZ tier 248, and a data plane data tier 250. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way: the service gateway can make API calls to cloud services, and cloud services can send requested data to the service gateway. Generally, cloud services may not initiate API calls to the service gateway.

In accordance with an embodiment, the secure host tenancy can be directly connected to the service tenancy, which may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example create, read, update, or delete (CRUD) operations, through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both of which may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage, which may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy, which may be isolated from the public Internet.

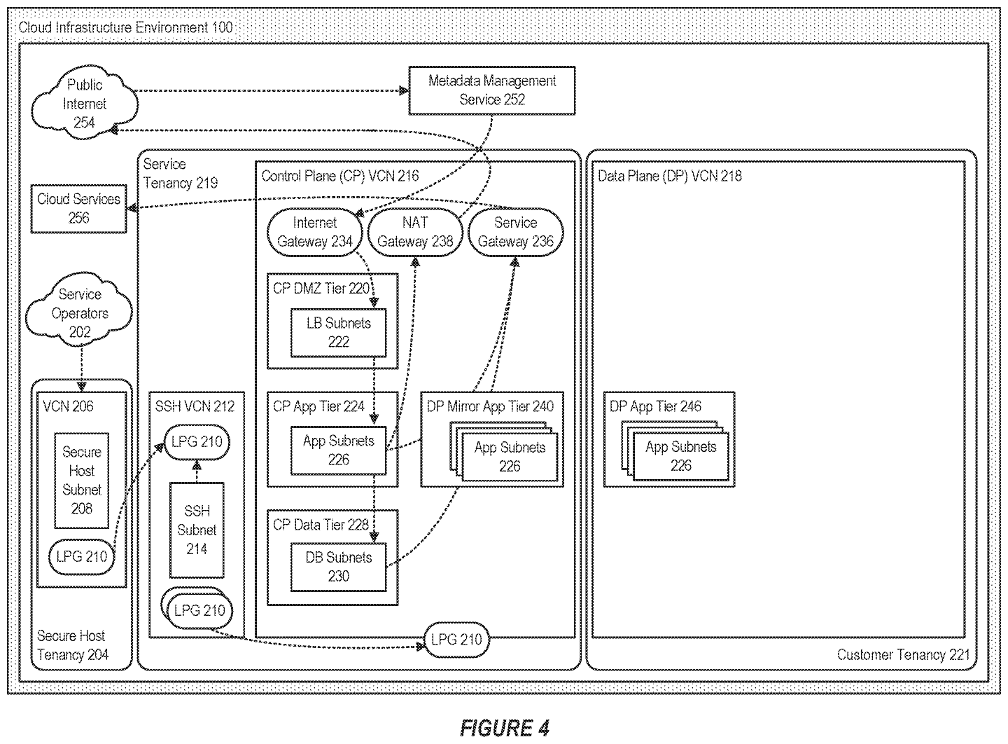

FIG. 4 illustrates another example of a cloud infrastructure architecture, in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources that are provisioned in the control plane VCN that is contained in the service tenancy, to be deployed or otherwise used in the data plane VCN that is contained in the customer tenancy.

In accordance with an embodiment, a customer of the cloud infrastructure provider may have databases that are managed and operate within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, of the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with Deployment 1 in Region 2.

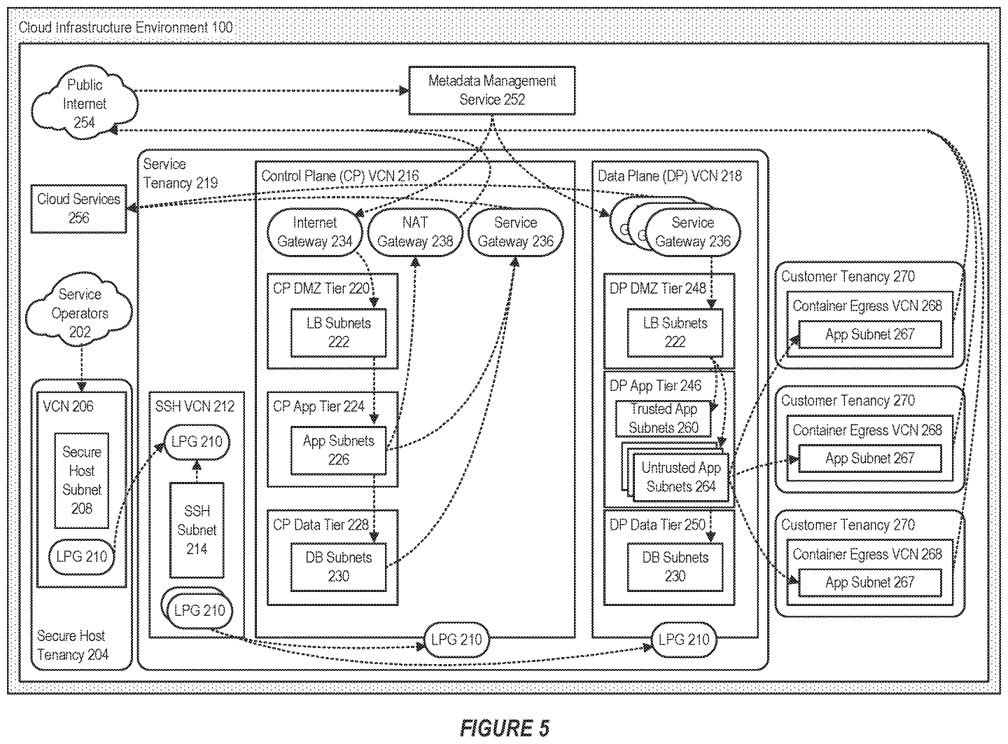

FIG. 5 illustrates another example of a cloud infrastructure architecture, in accordance with an embodiment.

As illustrated in FIG. 5, in accordance with an embodiment, the trusted app subnet(s) 260 can be communicatively coupled to the service gateway contained in the data plane VCN, the NAT gateway contained in the data plane VCN, and DB subnet(s) contained in the data plane data tier. The untrusted app subnet(s) 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs, and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)), which may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s), and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled; or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

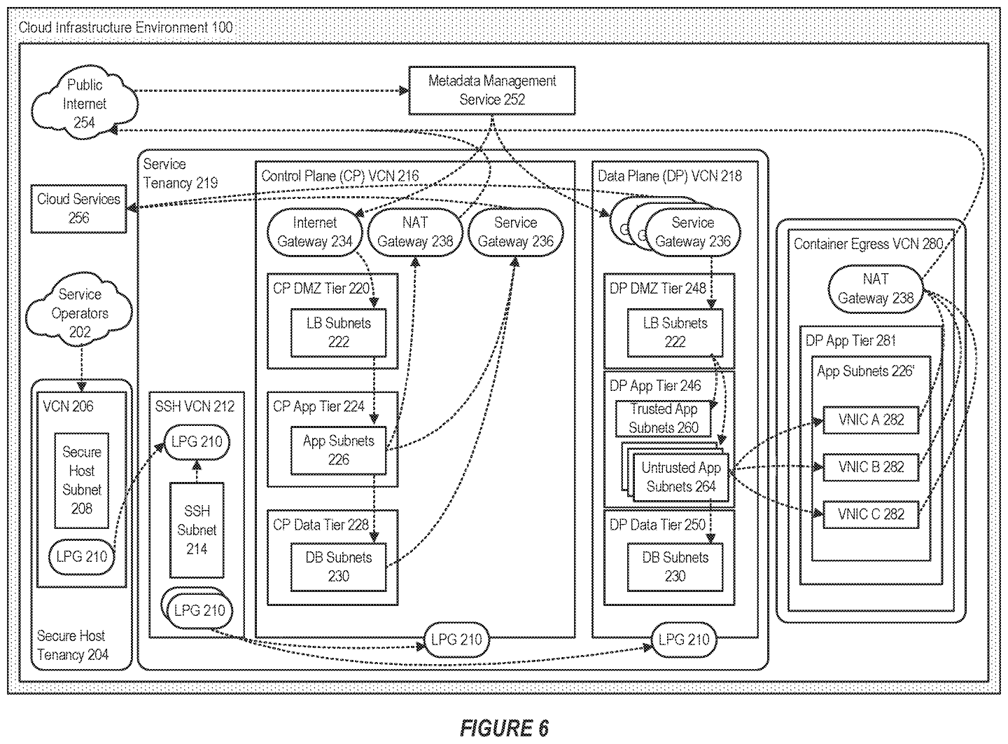

FIG. 6 illustrates another example of a cloud infrastructure architecture, in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container, and be communicatively coupled to an app subnet that can be contained in a data plane app tier 281 that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that requests a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Cloud Environments

In accordance with an embodiment, a cloud infrastructure environment can be used to provide dedicated cloud environments, for example as one or more private label cloud environments, for use by tenants of the cloud infrastructure environment in accessing subscription-based software products, services, or other offerings associated with the cloud infrastructure environment.

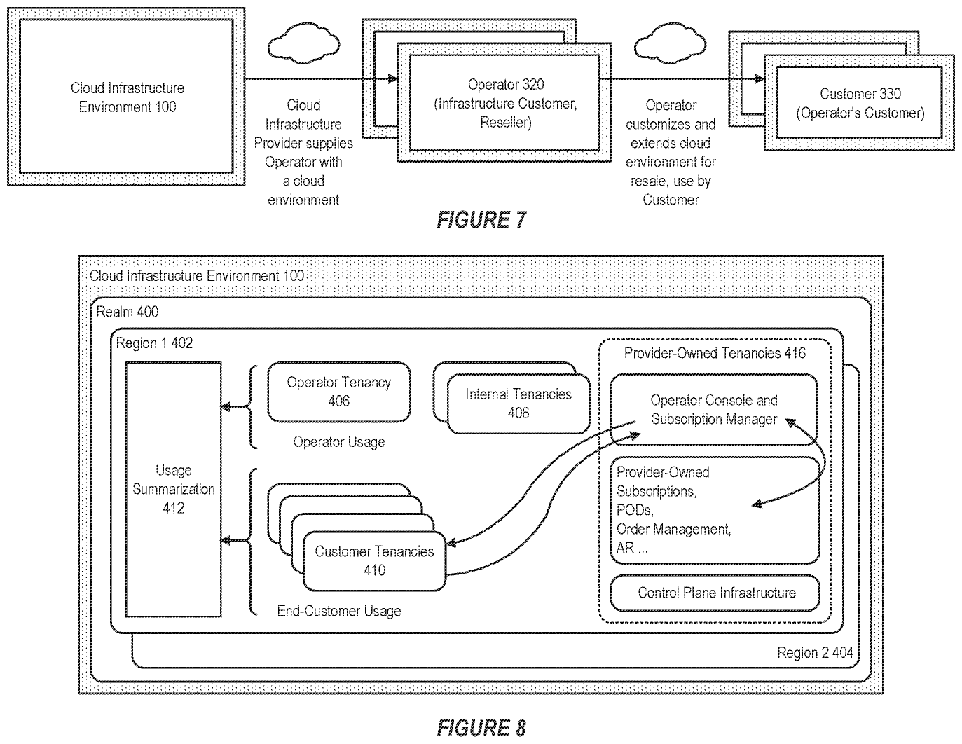

FIG. 7 illustrates how the system can provide dedicated or private label cloud environments, for use by tenants or customers of a cloud infrastructure environment, in accordance with an embodiment.

Although several of the examples described herein illustrate various systems, methods, and/or techniques as may be used in the context of providing private label cloud (PLC) environments, in accordance with various embodiments, the systems, methods, and techniques described herein can be used, within or with other types of cloud environments.

As illustrated in FIG. 7, in accordance with an embodiment, a cloud infrastructure provider can supply an operator 320, for example a cloud infrastructure customer operating as a reseller, with one or more cloud environments (e.g., a PLC environment) or realms. The operator/reseller can then customize and extend the cloud environment for use by (their) customer 330, for use in accessing subscription-based software products, services, or other offerings associated with the cloud infrastructure environment.

For purposes of illustration, examples of such subscription-based products, services, or other offerings may include various cloud infrastructure software products, such as Oracle Fusion Applications products, or other types of products or services that allow customers to subscribe to usage of those products or services.

FIG. 8 further illustrates the use of cloud realms, for use by tenants or customers of a cloud infrastructure environment, in accordance with an embodiment.

As illustrated in FIG. 8, in accordance with an embodiment, the system can include a cloud subscription service or component, referred to herein in some embodiments as a subscription manager, that exposes one or more subscription management APIs for creating orders used to onboard new customers, or to launch a workflow that creates a subscription and orchestrates billing and pricing service or other components for use with a cloud realm 400.

In accordance with an embodiment, when an operator (e.g., a PLC operator) or their customer requests a cloud environment, the system creates a realm, for use within a region 402, 404; together with one or more provider-owned tenancies 416. These tenancies allow a region to function with its required service infrastructure; and are administered by the cloud infrastructure provider.

In accordance with an embodiment, a first step in the process is to create an operator tenancy 406 for the operator, before the region and associated realms are turned over to them for subsequent management. The operator then becomes the administrator of this tenancy, within which they can view and manage everything that happens within that region, including their customer accounts and usage 412 by those customers of cloud resources.

Generally, once the region has been turned over or provided to the operator, the cloud infrastructure provider cannot subsequently access the data within the operator tenancy, unless the operator authorizes the cloud infrastructure provider to do so, for example to provide troubleshooting of issues that may arise.

In accordance with an embodiment, the operator can then create additional internal tenancies 408, intended for their own use internally, for example to assess what the end user or customer experience will be, or to provide a sales demo tenancy, or to operate a database for their own internal use. The operator can also create one or more customer tenancies 410, of which the end user or customer will be the administrator. Cloud infrastructure usage, for example compute, storage, and other infrastructure resources, is consolidated by operator, reflecting both their usage and that of their customers, and reported to the cloud infrastructure provider.

In accordance with an embodiment, a user interface or console can be provided that allows the operator to manage its customer accounts and customer-offered services. A cloud infrastructure provider can also use a cloud infrastructure tenancy, for example a Fusion Applications tenancy, to install any needed infrastructure services for use by the operator and their customers.

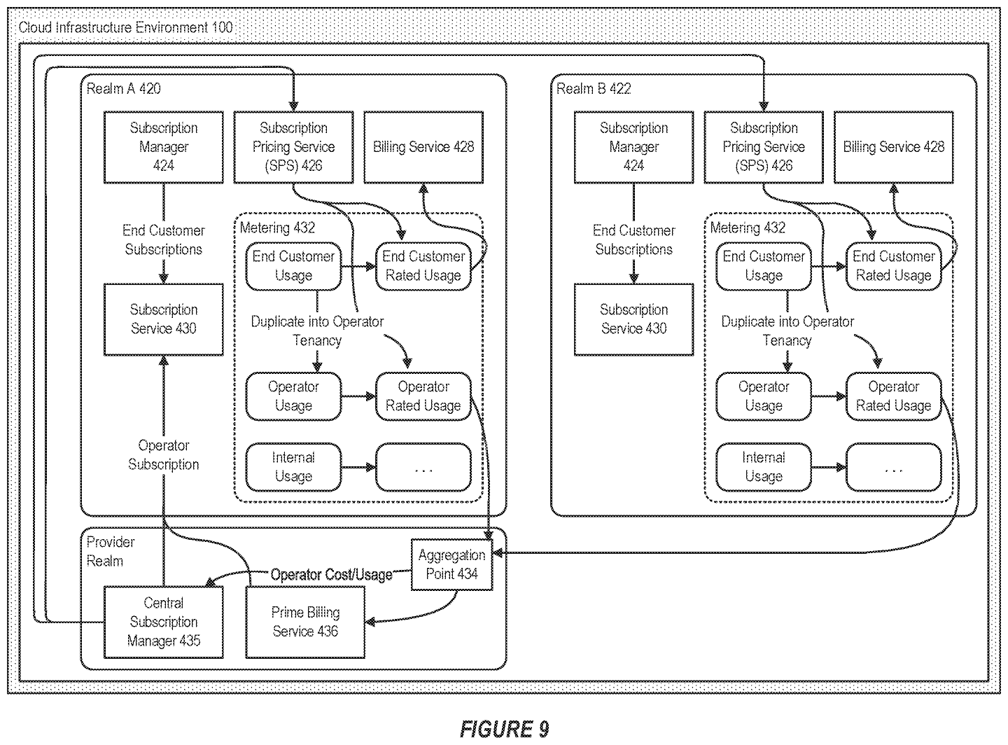

FIG. 9 further illustrates the use of cloud realms, for use by tenants or customers of a cloud infrastructure environment, in accordance with an embodiment.

As illustrated in FIG. 9, in accordance with an embodiment, a subscription manager 424 service or component exposes one or more subscription management APIs for creating orders used to onboard new customers, or to launch a workflow that creates a subscription and orchestrates billing and pricing service or other components.

In accordance with an embodiment, the system can also include a billing service 428 or component that operates upon a billing account or logical container of subscriptions and preferences used to produce an invoice for a customer.

In accordance with an embodiment, the system can also include a subscription pricing service (SPS) 426 or component, which operates upon a product catalog that defines which products can be purchased by a customer, and can be used to provide a price list (e.g., a rate card) that the pricing service also owns.

In accordance with an embodiment, to support the sales process through which a subscription is created in a realm 420, 422, products can be selected from a product hub. Once an order is created via a subscription service 430, a subscription is created in the subscription manager which thereafter manages the life cycle of that subscription, and provisions what needs to be provisioned in downstream services. The SPS component then manages the aspects of pricing and usage, for use in charging the end cost to the operator or their ability to charge their customers. Usage events are forwarded to the billing service or component, where depending on the billing preferences of the subscription, invoices are created and pushed to an accounts receivables component.

In accordance with an embodiment, although the services that are offered in a realm report their usage to a metering service or component 432, such usage does not have any price associated with it. A rating process determines how much each specific event costs, for example by applying rate cards, determines a unit and cost for that subscription, associates the cost to that record, and then forwards that to the billing service or component.

As further illustrated in FIG. 9, in accordance with an embodiment, an operator may control multiple realms A, B—for example an operator that operates in multiple countries may wish to operate a data center that is completely isolated for the United States of America, and a separate data center that is completely isolated for Europe, for example to address governance or regulatory requirements. In accordance with an embodiment, the usage associated with these multiple realms can be aggregated 434, for use by a central subscription manager 435, and where applicable a prime billing service 436, in billing the operator.

The examples of various systems illustrated above are provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Cloud Subscriptions

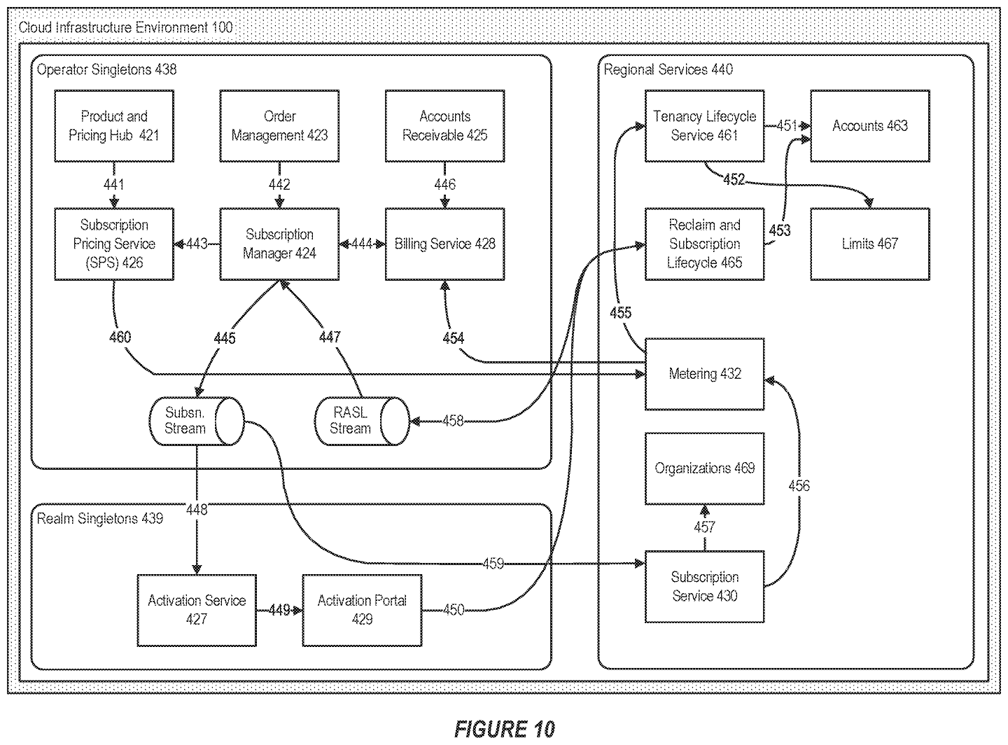

FIG. 10 illustrates a system for providing access to software products or services in a cloud computing or other computing environment, in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various cloud infrastructure software products or services that allow customers to subscribe to usage of those products or services.

In accordance with an embodiment, the environment can include a plurality of components provided as operator singletons 438, realm singletons 439, and regional services 440, as further described below.

In accordance with an embodiment, a subscription can include artifacts such as, for example, products, commits, billing model, and state. The subscription manager service or component can expose one or more subscription management APIs for creating orders used to onboard new customers, or to launch a workflow that creates a subscription and orchestrates creating the proper footprints in billing and pricing service or components, as further described below.

In accordance with an embodiment, the billing service or component operates upon a billing account or logical container of subscriptions and preferences used to produce an invoice. Each billing account generates one invoice per billing cycle. The billing service includes a first pipeline that accepts usage and cost from a metering service or component through a REST API, wherein billing writes the usage to a database from which billing workers aggregate and calculate balances; and a second pipeline responsible for taking the aggregated usage and commitments and calculating charges over a billing interval.

In accordance with an embodiment, the subscription pricing service (SPS) 426 or component operates upon a product catalog that defines which products can be purchased by a customer. The product catalog forms the backbone of a price list (i.e., rate card) that the pricing service also owns. Rate cards are modeled as pricing rules on top of public list prices. The pricing service maintains a single price list for all products, new product prices can be added, and existing prices changed. The price list has a full history, the latest version being the current rate card. Since some contracts may require a snapshot of the rate card be taken, the pricing service handles this by recording the time a customer's rate card is created, and then querying the price list at that time.

In accordance with an embodiment, the SPS or pricing service is responsible for communicating with a product and pricing hub 421, to provide information about products, global price list, and end user or customer's subscription specific price lists and discounts. For example, in accordance with an embodiment, SPS can synchronize product information from a product hub, and a global price list from a pricing hub.

In accordance with an embodiment, the subscription manager service or component operates as an upstream service to receive new order requests from an order management 423 component, for example from an Oracle Fusion Order Management environment. The subscription manager service or component can provide subscription information to the SPS service, including subscription details such as time of quote configured, or subscription type (Commitment, PayG), to help SPS to determine an effective base price (Rate Card) for the subscription. The subscription manager service or component can also send discounts for subscriptions received from the order management component, which SPS stores as a pricing rule entity.

In accordance with an embodiment, the SPS service runs as a background process to manage a rate cards service or component, which is responsible for generating rate cards for new subscriptions and updating those rate cards when new price changes occur. The SPS service can provide APIs to access rate cards and pricing rules. A metering in-line rating engine can utilize these APIs to obtain subscription-specific rate cards and pricing rules, and then use this data for cost calculations.

In accordance with an embodiment, additional SPS components can include, for example, a pricing/product hub integration component, that allows an operator entity providing subscription-based products, services, or other offerings within the environment, to manage their product and price list, for example as provided by a product hub and pricing hub respectively.

For example, in accordance with such an embodiment, an SPS product integration flow can listen to create/update events in the product hub and make calls to an SPS product API. Similarly, an SPS pricing integration flow can pull new price list creation from the pricing hub and call respective SPS pricing APIs.

In accordance with an embodiment, the system can also include an SPS core module that provides APIs to manage and access pricing entities. Pricing entities can be accessed by internal services, for example an inline rating engine.

In accordance with an embodiment, the system can also include a rate card manager component. The SPS service maintains the single base price for a product at a given time. However, product prices for subscription are dependent on a base price at quote configuration time and price list change policy attributes of subscriptions. The SPS service internally maintains the price to be used for subscription using these properties. All such price lists are grouped in a rate card. The rate card manager can create and maintain the rate card, listen to price list changes and update existing rate cards with the new price, and listen to new subscriptions and assigns the rate card based on subscription properties.

In accordance with an embodiment, the SPS service is responsible for managing pricing rules for a subscription, including discounts offered to an end user or customer. Pricing rules eligibility can be based on attributes of products, such as discount group, product category or specific SKUs. Internally SPS needs to identify the list of products for which these rules will be applicable. To accomplish this, a rule decoder engine can compile the pricing rules in a format such that an in-line rating engine can consume the information for cost calculation. This compilation process can be triggered when products or pricing rules are created or updated.

As illustrated by way of example in FIG. 10, in accordance with an embodiment: at 441, a product and price information managed in, e.g., Fusion Applications, is sent to the SPS component.

At 442, orders are sent to the subscription manager component to create subscriptions, rate cards and billing accounts.

At 443, pricing configuration and pricing rules are sent to SPS for new orders.

At 444, the subscription manager component is used to set up a billing account in the billing service or component.

At 445, the subscription manager component publishes events to an subscription manager streaming component.

At 446, a charge data is sent to an accounts receivable component 425 to generate invoices.

At 447, the subscription manager component consumes reclaim and subscription lifecycle (RASL) events from subscription manager streaming.

At 448, an activation service 427 reads the subscription manager event stream.

At 449, a customer obtains activation data from an activation portal 429.

At 450, a tenancy lifecycle service 461 provisions a tenancy as part of the subscription activation.

At 451, the tenancy lifecycle service creates, within an accounts 463 component, an accounts footprint during account provisioning.

At 452, the tenancy lifecycle service sets, within a limits service 467, a limits template during account provisioning.

At 453, the accounts component acts as a downstream RASL client to handle a legacy reclamation and subscription lifecycle 465.

At 454, aggregated cost and usage is sent to the billing service 428 or component.

At 455, an organization can create child tenancies using the tenancy lifecycle service.

At 456, a metering service 432 or component obtains subscription mapping data.

At 457, the subscription service 430 obtains organization data 469 for subscription mappings.

At 458, the RASL component reads the subscription manager event stream.

At 459, the subscription service reads the subscription manager event stream; and at 460, the metering service or component obtains a rate card data for each subscription, which can then be used in charging the end cost to the operator or their ability to charge their customers.

The above examples are provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Service Control Policies

Within a cloud infrastructure environment, there may not be appropriate control mechanisms for cloud operators (including cloud infrastructure providers themselves) to manage the offerings available to end users (e.g., customers).

For example, a cloud infrastructure provider's internal service teams may use a complex set of limits templates, features flags, and allow lists, for releasing functionality only when/were supported. However, such controls are not suitable for use by an external, e.g., PLC realm operator or administrator.

In accordance with an embodiment, the system comprises a service control repository or service catalog that provides a definition of the services and service features, together with service control policies (SCPs) or rules that define availability or access to the service features. A service control policy framework, comprising a feature management service, determines, by reference to a hierarchy of entities defining the service control policies, which different entities can control the availability of particular services or service features to end users.

In accordance with an embodiment, a service control policy can be controlled by a hierarchy of entities or at multiple levels. At each level within the hierarchy, only the service features that have been made available by a higher-level entity can be controlled by a service control policy at that level.

In accordance with an embodiment, when used in cloud infrastructure environments that offer services or service features as products to customers, for example on a subscription basis, the service catalog can operate in the manner of a product catalog for use with those products.

In accordance with an embodiment, the feature management service determines how different entities, e.g., a cloud infrastructure provider, or realm operators themselves, can control which services or service features are to be made available to end users (e.g., tenants).

For example, cloud infrastructure provider service teams can define service features or functionalities of services which they want to expose to operators or end users (e.g., customers) for management or use thereof. A service control policy (SCP) is then used to restrict the availability of those service features to particular operators and customers.

Such a hierarchy reflects a reseller model; wherein for example, at a first or higher-level, a cloud infrastructure provider needs to enable a particular service feature, and then at a second or lower-level an, e.g., realm operator, needs to enable the feature for use by its customers.

Although several of the examples described herein illustrate various systems, methods, and/or techniques as may be used in the context of providing private label cloud (PLC) environments, in accordance with various embodiments, the systems, methods, and techniques described herein can be used, within or with other types of cloud environments.

In accordance with an embodiment, an example process for determining if a service feature is enabled (available) or disabled (unavailable) can include:

If, at a first level of a hierarchy of entities defining the service control policies, a service control policy is found for disabling a particular service feature that matches a particular criteria, then the associated service feature is indicated as disabled or unavailable (for use by, e.g., the requesting cloud infrastructure provider, realm operator, tenant, or customer).

If a service control policy is found for enabling the service feature that matches the criteria, the workflow will continue to scan within the hierarchy of entities defining the service control policies for any policy disabling the service feature that matches the criteria; if none are found, then the associated service feature is indicated as enabled or available.

In accordance with an embodiment, a management user interface or console associated with managing a service provides an adaptive user experience based on assessing the service control policies associated with a particular service or service feature. For example, console interface elements can be removed or greyed-out based on a feature unavailability, as determined by the service control policy.

For example, when a realm operator or customer's environment is accessed via a console for purposes of managing services therein, if a particular service or an associated service feature is disabled or turned off, then its functionality is hidden by the console plugin.

In accordance with an embodiment, the feature management service can determine access by particular operators or users within particular tenancies or regions to particular service features, by assessing a hierarchy of the service control policies and relationships associated with the particular service features and determining a state associated with the service and/or its associated service feature.

As another example, in the case of a data plane service, a determination can be made for a particular tenant or customer (of an operator) whether the data plane service, or one or more associated service features thereof, is enabled for use by the particular tenant or customer.

As another example, in the case of allocating resources to an, e.g., tenant or customer, such as increasing a number of compute units for their use, the feature management service can be used to determine if a particular service feature is enabled for a particular service (e.g., a data plane service), for that tenant or customer, and then, based on the assessed state of that service feature, either approve or refuse the requested operation.

In accordance with an embodiment, various details of particular implementations or embodiments are provided below. The description is provided for the purposes of illustrating the teachings herein; and is not intended to be exhaustive or to limit the scope of protection to the precise forms disclosed. Many modifications and variations will be apparent to the practitioner skilled in the art.

| Term | Description |
|---|---|
| PLC | Private Label Cloud. |
| Feature | Controllable unit of functionality within a service. |
| Console | Feature flags stored, for example, inside the |
| Allowlists | limits service, used by console plugins to control |
| | the user experience behavior and functionality. |
| SCP | Service Control Policy; a policy to control the |
| | availability of the features inside a service. |
| Operator | The different personas that can manage features, |
| | for example: a service team, realm operator, and |
| | organization or tenancy administrator. The operator |
| | will be ordered by priority into multiple levels/layers |
| | as such: cloud infrastructure provider service team |
| | (higher), real operator, organization, tenancy admin (lower) |
| Realm | Any operator that is responsible for a realm level |
| Operator | deployment, for example a PLC operator. |
| Organization | A group of tenancies: one parent and zero-to-many |
| | children, with shared usage and unified reporting. |

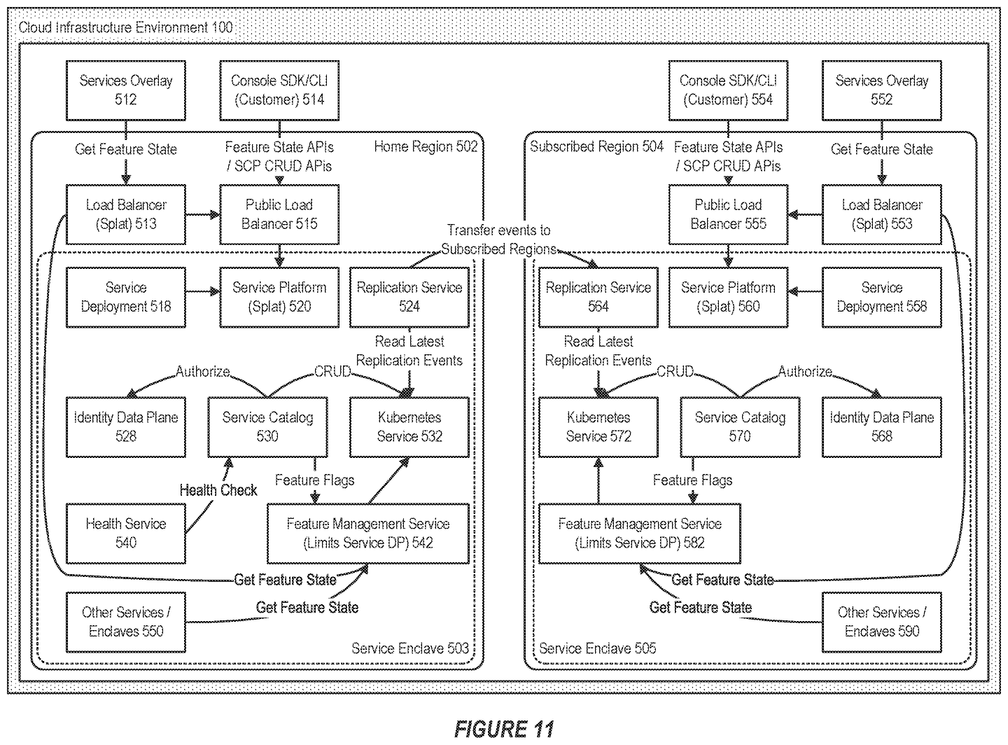

FIG. 11 illustrates an example cloud infrastructure environment that can use service control policies, in accordance with an embodiment.

As illustrated in FIG. 11, in accordance with an embodiment, and provided by way of example to illustrate the methods described herein, a cloud infrastructure environment can include one or more home region 502 and subscribed region 504, each of which can include a service enclave 503, 505 that provides services and service features.

In accordance with an embodiment, a services overlay 512, 552 allows access to services provided within the cloud infrastructure environment via a load balancer 513, 553 in communication with a service platform 520, 560 (Splat) that implements an internal API gateway, which provides access to services and service features, and provides a feature state for use in processing requests.

In accordance with an embodiment, a console 514, 554, for example a software development kit (SDK) or command line interface (CLI), operated by a customer, can access the services provided within the cloud infrastructure environment and associated service features via a public load balancer 515, 555 and feature state API's that allow create, read, update and delete (CRUD) operations.

In accordance with an embodiment, within a service enclave, the system can include various components that support access to services, including, for example, a service deployment component 518, 558 that provides deployment of services within the cloud infrastructure environment; a replication service 524, 564 that transfer events from the home region to one or more subscribed regions; and an identity data plane 528, 568 that provides authorization of requests. A service catalog 530, 570 (product catalog) operates as a service control repository in storing a definition of the services and service features, together with service control policies or rules that define availability or access to the service features. A Kubernetes or other service 532, 572 operates to maintain the state of the services and service features; while a limits service health component 540 that performs health checks on the service catalog.

In accordance with an embodiment, the feature management service, (which in some embodiments as illustrated below can be provided by a limits service data plane) 542, 582 can operate as described below, for example to provide feature states in response to requests. In accordance with other embodiments, the feature management service can be provided as a separate component. Other services/enclaves 550, 590 can similarly access the limits service data plane (feature management service) to obtain feature states.

The above example is provided for the purposes of illustrating the teachings herein; and is not intended to be exhaustive or to limit the scope of protection to the precise forms disclosed; in accordance with other embodiments other types of architectures can be provided to implement or perform the methods described herein.

### Service and Feature States

In accordance with an embodiment, the system comprises a service control repository or service catalog that provides a definition of the services and service features, together with service control policies or rules that define availability or access to the service features. Features can be grouped inside services, and the associated metadata stored inside a service catalog database.

Generally, service and feature definitions are managed by the cloud infrastructure provider's internal service team that owns those services or features. Other operators will not be able to change the definitions for these entities.

In accordance with an embodiment, feature availability operates in the manner of a stream of permissions or approvals, flowing from a higher-level, the internal operator, to the lower-level, the customer. Any operator in the process can choose to stop the flow at their level, which will block it for any other lower-level operators and customers.

In accordance with an embodiment, service features support at least two states: available, wherein the feature is available for the lower-level operator or the users; and unavailable, wherein the feature is hidden from the lower-level operators and users. Additional states that can be supported include, for example, deprecated, or retired. In accordance with an embodiment, the end user or customer will be the one actually using the service features. For other operators, an unavailable feature will mean they will not be able to control it or offer it to their tenancies/customers.

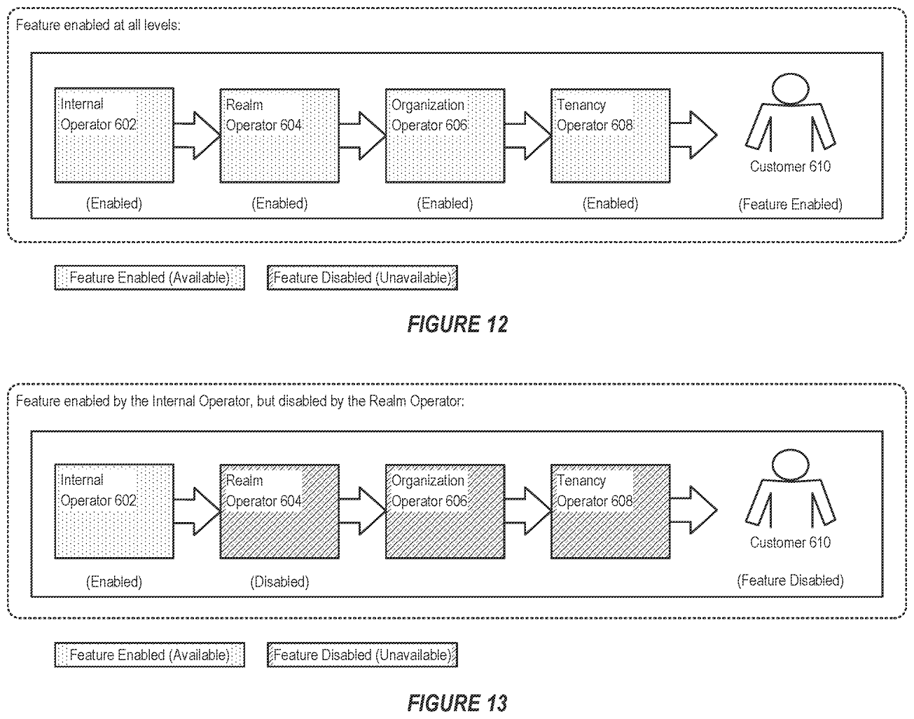

FIG. 12 illustrates how services or service features can be enabled or disabled according to a hierarchy of entities defining the service control policies, in accordance with an embodiment.

As illustrated in FIG. 12, in accordance with an embodiment, a hierarchy of entities defining the service control policies or levels includes those provided by an internal operator 602, realm operator 604, organization operator 606, and tenancy operator 608. In the illustrated example, the particular service feature is enabled at all interim levels, rendering the feature enabled for the end user or customer 610.

FIG. 13 further illustrates how services or service features can be enabled or disabled according to a hierarchy of entities defining the service control policies, in accordance with an embodiment.

As illustrated in FIG. 13, in accordance with an embodiment, and in the illustrated example, the particular service feature is enabled by the internal operator, but is disabled by the realm operator, rendering the feature disabled for the end user or customer.

In accordance with an embodiment, the use of a hierarchy of service control policies allows the status of a particular service feature to be controlled at multiple levels, each corresponding to a particular operator. At each level within the hierarchy, only the features made available by the higher-level can be controlled as described above. For example, the service control policies created at different levels can be evaluated sequentially starting from those created by the higher-level operator to those created by the tenancy administrators.

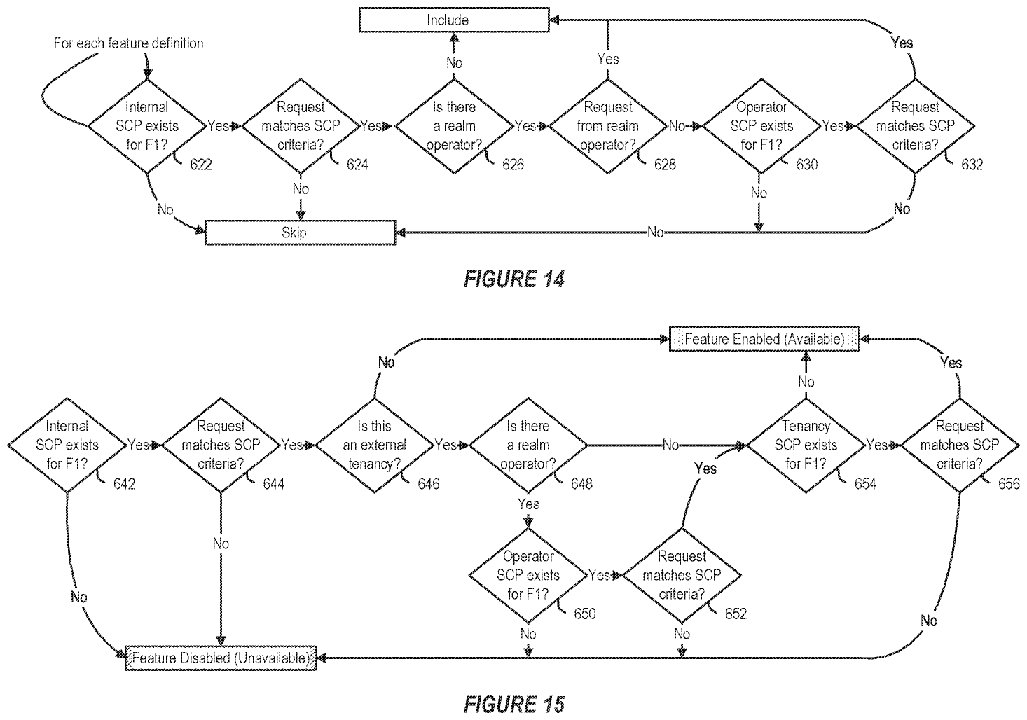

FIG. 14 illustrates a process for use with service control policies to enable or disable availability or access to service features, in accordance with an embodiment.

As illustrated in FIG. 14, in accordance with an embodiment, a process can be used to determine whether a service or feature is to be included in the service catalog and made available to a customer.

For each feature definition, at 622, a determination is made as to whether a service control policy exists for that feature (F1).

If a service control policy exists for the service feature, then, at 624, a determination is made as to whether the request matches the service control policy criteria.

If the request matches the service control policy criteria, then, at 626, a determination is made as to whether there is a realm operator.

If, at 628, the request is determined to be from the realm operator then the service feature definition is included in the service catalog and made available to a customer.

Otherwise, at 630, a determination can be made as to whether an operator service control policy exists for the service feature, and, at 632, whether the request matches the service control policy criteria. If both of these are found to be true, then the service feature definition is included.

FIG. 15 illustrates another process for use with service control policies to enable or disable availability or access to service features, in accordance with an embodiment.

As illustrated in FIG. 15, in accordance with an embodiment, a process can be used to determine whether a service or feature is to be enabled or disabled for use by a particular customer.

At 642, a determination is made as to whether an internal service control policy exists for that feature (F1).

If an internal service control policy exists for the service feature, then, at 644 a determination is made as to whether the request matches the service control policy criteria.

At 646, a determination is made as to whether the request is associated with an external tenant, if not the service feature is enabled or made available, and the process ends.

If, at 648, there is a realm operator then, at 650, a determination is made whether an operator service control policy exists for the service feature and, at 652, if the request matches the service control policy criteria.

If both of these are found to be true, then, at 654, a determination is made as to whether a tenancy service control policy exists for the service feature, and, at 656, if the request matches the service control policy criteria, in which case the service feature is enabled.

If at any stage in the process (e.g., at 644, 652, 656) the request does not match the service control policy criteria at that stage, then the service feature is disabled or rendered unavailable.

### Internal API for Service and Feature Definition

In accordance with an embodiment, a service platform (Splat) implements an internal API gateway, for providing access to services and service features and a feature state for use in processing requests.

In accordance with an embodiment, the API can be provided as control plane (CP) APIs usable by a cloud infrastructure provider's internal service teams to define and manage their services and service features.

### Service Definition

In accordance with an embodiment, an example of various API operations used to define a service are illustrated below:

| Path | Verb | Operation | Parameters | Permission | Details |
|---|---|---|---|---|---|
| /serviceDefinitions | GET | listServiceDefinitions | compartmentId | SERVICE_ | List all service |
| | | | serviceName | DEFINITION_ | definitions |
| | | | (optional) | INSPECT | entities. |
| | POST | createServiceDefinition | serviceName | SERVICE_ | Create a |
| | | | compartmentId | DEFINITION_ | service |
| | | | description | CREATE | definition |
| | | | statesBehavior | | entity. |
| | | | (optional) | | |
| /serviceDefinitions | GET | getServiceDefinition | serviceDefinitionId | SERVICE_ | Get service |
| /{serviceDefinitionId} | | | | DEFINITION_ | definition. |
| | | | | READ | |
| | PUT | updateServiceDefinition | serviceDefinitionId | SERVICE_ | Update service |
| | | | | DEFINITION_ | definition. |
| | | | | UPDATE | |
| | DELETE | deleteServiceDefinition | serviceDefinitionId | SERVICE_ | Delete |
| | | | | DEFINITION_ | the service |
| | | | | DELETE | definition. |

In accordance with an embodiment, the above operations can utilize various fields, for example:

| Field | Type | Required | Description |
|---|---|---|---|
| id | String | Yes | Unique identifier. |
| name | String | Yes | The name of the service; |
| | | | identifier type value (no |
| | | | spaces, no special characters); |
| | | | unique across all entities. |
| compartmentId | String | Yes | The compartment ID of the |
| | | | owning team. |
| description | String | Yes | The description of the service. |
| statesBehavior | String | No | JSON map of the behavior |
| | | | associated with each state. |

### Feature Definition

In accordance with an embodiment, an example of various API operations used to define a service feature are illustrated below:

| Path | Verb | Operation | Parameters | Permission | Details |
|---|---|---|---|---|---|
| /featureDefinitions | GET | listFeatureDefinitions | compartmentId | FEATURE_ | List all feature |
| | | | serviceName | DEFINITION_ | definitions entities. |
| | | | (optional) | INSPECT | |
| | POST | create FeatureDefinition | serviceName | FEATURE_ | Create a feature |
| | | | featureName | DEFINITION_ | service definition |
| | | | compartmentId | CREATE | entity. |
| | | | description | | |
| | | | forceAvailable | | |
| | | | limits | | |
| | | | statesBehavior | | |
| /features Definitions | GET | getFeatureDefinition | featureDefinitionId | FEATURE_ | Get feature |
| /{featureDefinitionId} | | | | DEFINITION_ | definition. |
| | | | | READ | |
| | PUT | updateFeatureDefinition | feature DefinitionId | FEATURE_ | Update feature |
| | | | | DEFINITION_ | definition. |
| | | | | UPDATE | |
| | DELETE | deleteFeatureDefinition | feature DefinitionId | FEATURE_ | Delete the feature |
| | | | | DEFINITION_ | definition. |
| | | | | DELETE | |

In accordance with an embodiment, the above operations can utilize various fields, for example:

| Field | Type | Required | Description |
|---|---|---|---|
| id | String | Yes | Unique identifier |
| name | String | Yes | The name of the feature; identifier type value (no spaces, no special |
| | | | characters); unique inside a service. |
| serviceName | String | Yes | The service associated with the feature; must be a valid serviceName with an |
| | | | existing ServiceDefinition. |
| compartmentId | String | Yes | The compartment ID of the owning team; might be different than the |
| | | | ServiceDefinition compartmentld. |
| description | String | Yes | The description of the feature. |
| forceAvailable | Boolean | Yes | Forces the feature to be available by default for all lower-levels. |
| limits | String | False | JSON list of public limits associated with the service/feature/product. |
| internalOnly | Boolean | Yes | Set to true for features that a cloud infrastructure provider's internal service |
| | | | teams do not want to be exposed to lower-level operators. |
| statesBehavior | String | False | JSON map of what each state should affect the linked entities. |

In accordance with an embodiment, a states Behavior field can be provided as an optional field that will store any special behavior that maps to the states associated with a particular service or service feature, for example:

| Field | Type | Required | Description | Example |
|---|---|---|---|---|
| State | ENUM | True | The state covered | AVAILABLE |
| | | | by this entry. | |
| console- | ENUM | True | Overwrite the | HIDDEN |
| Behavior | | | default console | |
| | | | behavior associated | |
| | | | with the state. | |

In accordance with an embodiment, a cloud infrastructure provider's internal service teams can use an API to evaluate a particular feature, for example:

| Path | Verb | Operation | Parameters | Details |
|---|---|---|---|---|
| /features/ | POST | evaluate- | Payload | Evaluate the |
| evaluate | | Features | serviceName | corresponding |
| | | | list of featureNames | features. |
| | | | tenancyld | |
| | | | region | |
| | | | ad | |

In accordance with an embodiment, a cloud infrastructure provider's internal service teams can use an API to get the state of a particular feature, for example by realm or region, for example

| Path | Verb | Operation | Parameters |
|---|---|---|---|
| /features/state/ | GET | getFeature- | serviceName |
| service/{serviceName}/ | | StateForRealm | featureName |
| feature/{featureName}/ | | | tag |
| tag/{tag} | | | |
| /features/state/ | GET | getFeature- | serviceName |
| service/{serviceName}/ | | StateForRegion | featureName |
| feature/{featureName}/ | | | tag |
| tag/{tag}/region/{region} | | | region |
| /features/state/ | GET | getFeature- | serviceName |
| service/{serviceName}/ | | StateForAd | featureName |
| feature/{featureName}/ | | | tag |
| tag/{tag}/region/{region}/ad/{ad} | | | region |
| | | | ad |

In accordance with an embodiment, an API can be provided that allows a console to get a list of all disabled features for a particular tenancy and attributes, for example:

| Path | Verb | Operation | Parameters | Details |
|---|---|---|---|---|
| /features/console/{compartmentId} | GET | getFeaturesStatesForConsole | compartmentId | Return all the disabled |
| | | | | features and services |
| | | | | for the target tenancy. |

In accordance with an embodiment, other APIs can be provided to expose available services and service features for control by different operators, for example:

| Path | Verb | Operation | Parameters | Permission | Details |
|---|---|---|---|---|---|
| /services | GET | listServices | compartmentId | SERVICE_ | List all the services available. This will be used |
| | | | serviceName | CATALOG_ | by the operator UI. |
| | | | (optional) | INSPECT | |
| /features | GET | listFeatures | compartmentId | SERVICE_ | List all the features available. This will be used |
| | | | serviceName | CATALOG_ | by the operator UI. |
| | | | featureName | INSPECT | |
| | | | (optional) | | |

In accordance with an embodiment, the following rules apply when service control policy statements are evaluated: within a service control policy, statements are evaluated in order, and later statements supersede previous statements that target the same feature. In cases where more than one policy is set for the same resource, the most restrictive policy is applied (e.g., a policy to disable a particular service feature takes precedence over a policy to enable that service feature).

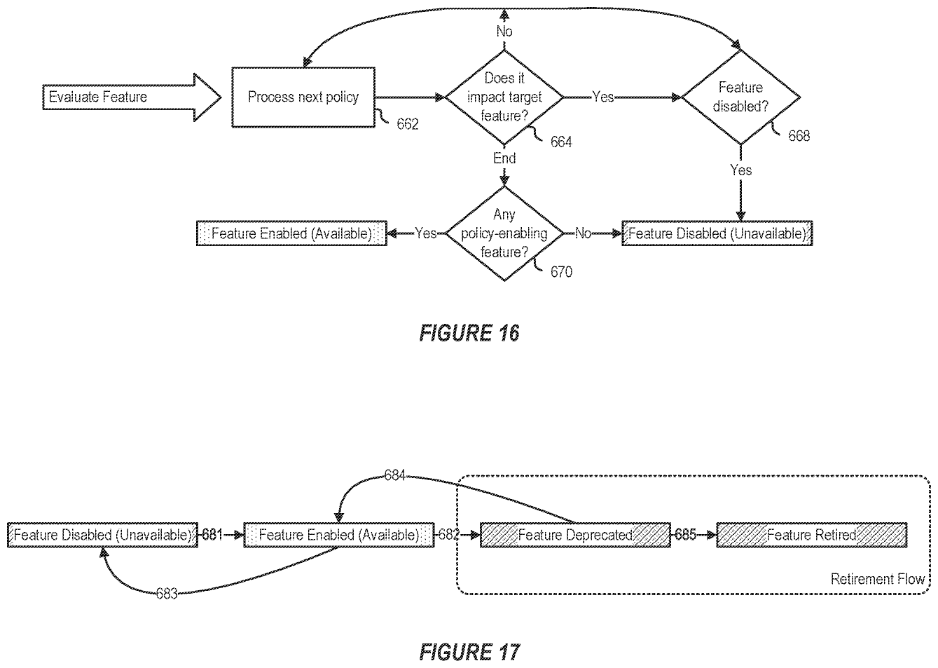

FIG. 16 illustrates another process for use with service control policies to enable or disable availability or access to service features, in accordance with an embodiment.

As illustrated in FIG. 16, in accordance with an embodiment, a process for evaluating the status of a service or feature can include, at 662, processing the (next) service control policy associated with the service or feature, and, at 664, determining whether that policy impacts the target feature.

If, at 668, a service control policy is found for disabling the service feature that matches the criteria, the result will be that the feature is disabled or rendered unavailable according to the policy.

If, at 670, a service control policy is found for enabling the service feature that matches the criteria, the workflow will continue to scan for any policy disabling the feature that matches the criteria. If none are found, then the service feature can be enabled or rendered available.

### State Transitions

FIG. 17 illustrates how a hierarchy of entities defining the service control policies can be used to indicate services or service features as enabled, disabled, deprecated, or retired, in accordance with an embodiment.

As illustrated in FIG. 17, in accordance with an embodiment, a feature status can be transitioned, at 681, from disabled to enabled; or, at 682, from enabled to deprecated. Similarly a previously-enabled feature can be transitioned, at 683, from enabled to disabled. A deprecated service feature can, at 684, be enabled if appropriate; or at 685, transitioned from a deprecated state to a retired state as part of a feature retirement flow.

In accordance with an embodiment, transitioning from unavailable to available will have a similar impact to releasing a feature from the customer's point of view.

However, marking a feature that is already available, and in use, as unavailable introduces some complexities: for example, users should still have access to their existing resources; users should not be able to create new resources; users would still need to have access to the appropriate console plugin to manage their existing resources.

As another example, users with no usage should not see the console plugin at all. Considering this, a service feature that has already been marked as available cannot be made unavailable; if operators want to mark the feature as being unavailable, they can use a feature retirement flow. The supported states will translate to the following API and console behavior for the operator:

| State | API Behavior | Operator UI |
|---|---|---|
| Unavailable | The operator cannot create | The operator cannot see |
| | policies for the feature. | the feature in the UI. |
| Available | The operator can create | The operator can see |
| | policies for the feature. | the feature in the UI. |

In accordance with an embodiment, the supported states will translate to the following API and console behavior for the end user:

| State | API Behavior | User Console Behavior | Console State |
|---|---|---|---|
| Unavailable | All API operations | The user cannot see the feature in the console. | HIDDEN |
| | are blocked | | |
| Available | All API operations | The user can see the feature and use it. | VISIBLE |
| | are allowed | | |
| Deprecated | Create operation | The user can still see the normal UI, but elements | UPDATE_ONLY |
| | is blocked | relating to the create workflow are disabled. | |
| Retired | All API operations | The user cannot see the feature in the console | HIDDEN |
| | are blocked | and cannot access the APIs. | |

### Use of Service Control Policies

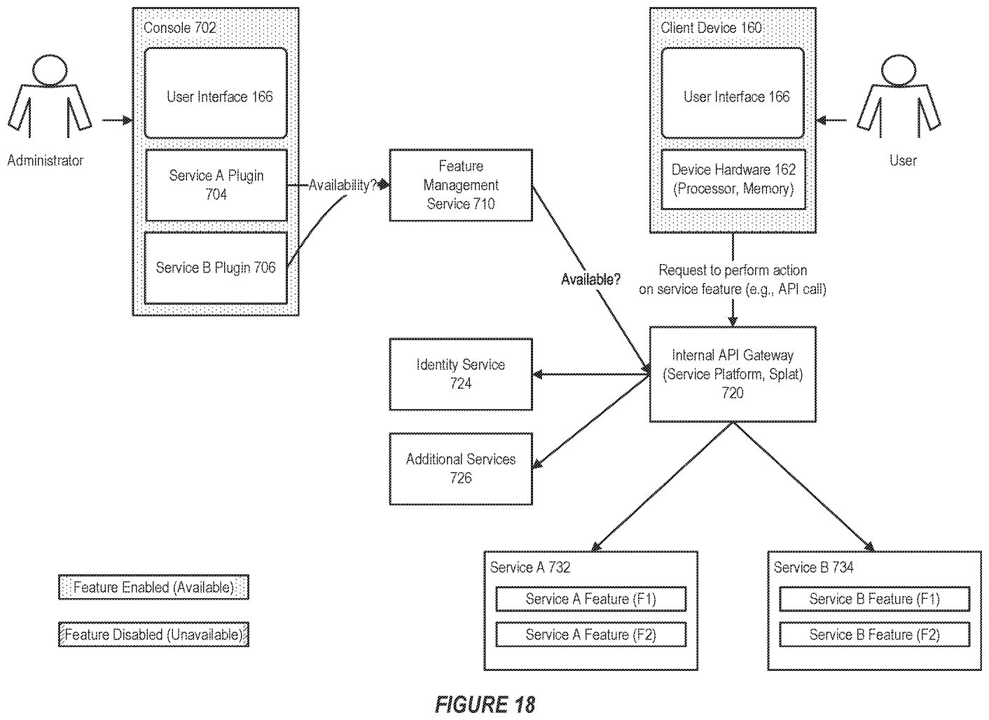

FIGS. 18-21 illustrate an example use of service control policies within a cloud infrastructure environment, in accordance with an embodiment.

As illustrated in FIG. 18, in accordance with an embodiment, a console 702 can include the use of one or more plugins that are associated with managing or using services or service features. In the illustrated example, a service A plugin 704 and service B plugin 706 can be associated with a respective service A 732 and service B 734, for purposes of managing those services or service features associated therewith.

In accordance with an embodiment, a feature management service 710 communicates with an internal API gateway 720 (for example as provided by a service platform, Splat, as illustrated above) that operates to receive requests, for example from clients devices or users to define availability or access to services or the features associated therewith; and provides availability information for use by the console plugins.

In accordance with an embodiment, the system can use other services, for example an identity service 724, or additional services 726 as appropriate, for example to determine information associated with the request such as a user, customer, compartment, or tenancy associated with the request.

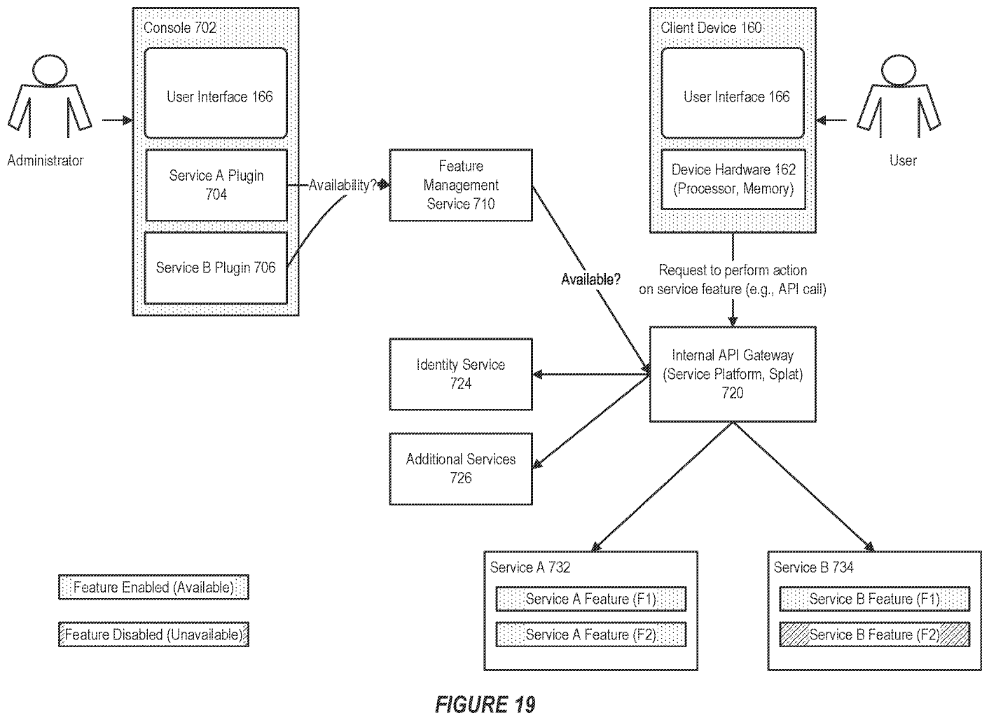

As illustrated in FIG. 19, in accordance with an embodiment, in the example illustrated, the feature management service in communication with the internal API gateway can determine, for example in response to a request, that for service A both of service features F1 and F2 are enabled or available; while for service B, feature F1 is enabled, and feature F2 is disabled for that request.

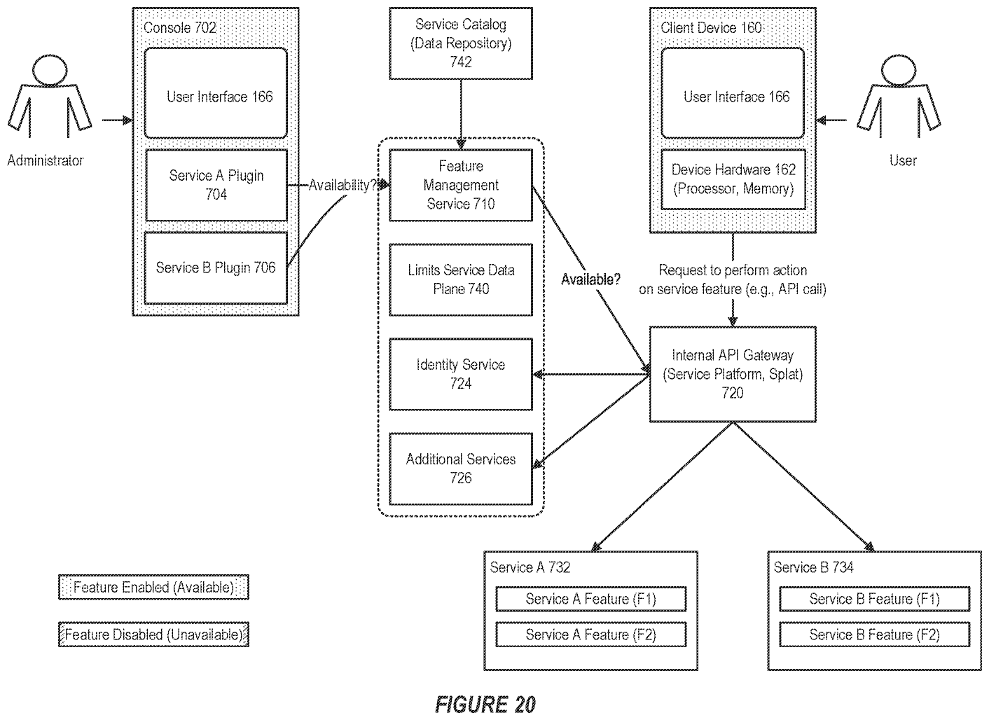

As illustrated in FIG. 20, in accordance with an embodiment, to perform its functionality, the feature management service can utilize a limits service data plane 740, that receives and processes requests, and a service catalog 742 (data repository) that provides a definition of the services and service features, together with service control policies or rules that define availability or access to the service features.

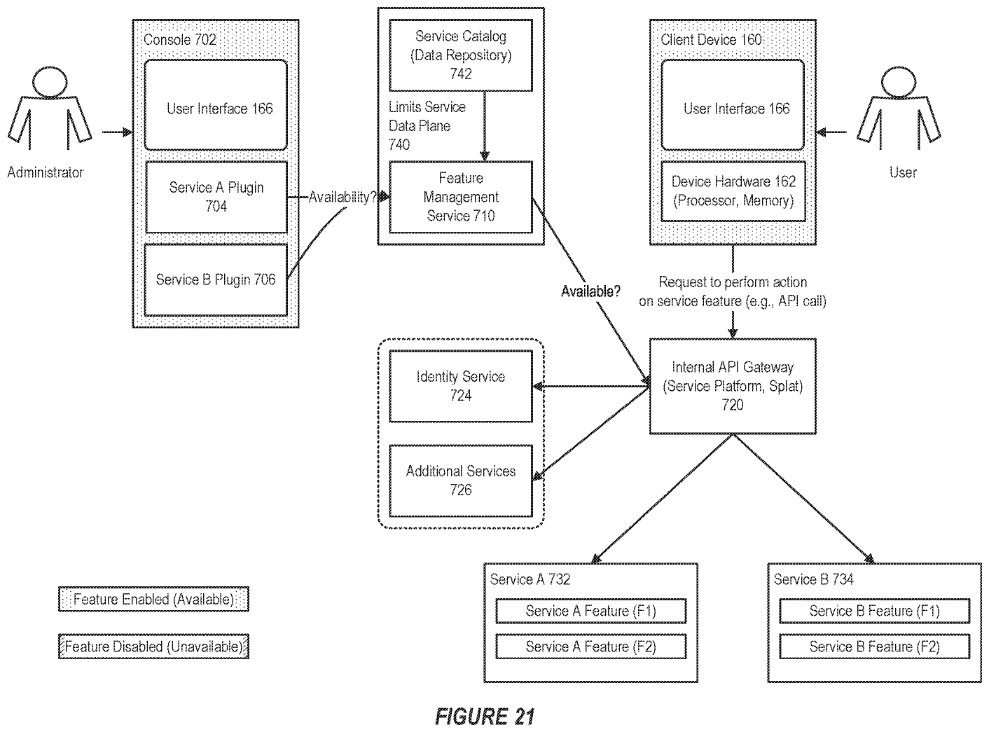

As illustrated in FIG. 21, in accordance with an embodiment, an existing limits service data plane can be modified to include the functionality of the feature management service and/or service catalog, for example to provide feature states in response to requests. In accordance with other embodiments, the feature management service can be provided as a separate component.

The above example is provided for the purposes of illustrating the teachings herein; and is not intended to be exhaustive or to limit the scope of protection to the precise forms disclosed; in accordance with other embodiments other types of processes or components can be provided to implement or perform the methods described herein.

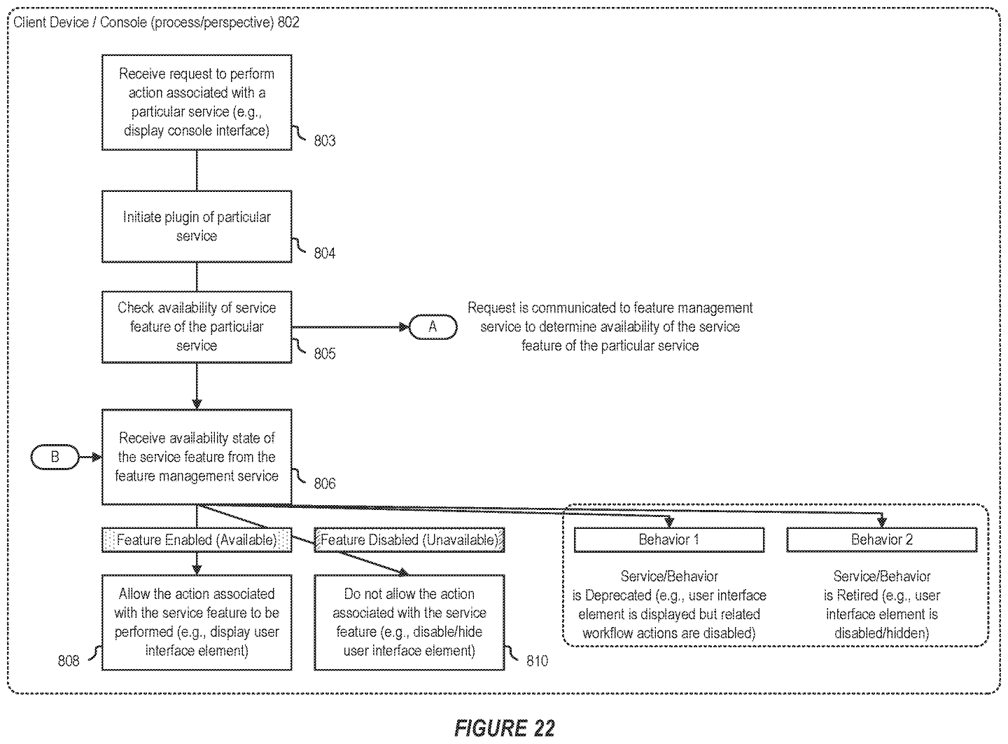

FIG. 22 illustrates a process of using service control policies to enable or disable availability or access to service features, from a perspective of a client device or console, in accordance with an embodiment.

In accordance with an embodiment, the process comprises providing, within a cloud infrastructure environment, a plurality of services for use by operators and tenants or users thereof; providing, within a service control repository, a plurality of service control policies or rules that define access to the services and service features; determining, in response to a request for access by a particular operator or tenant thereof to a particular service feature, by assessing the service control policies, a state associated with the service feature, indicative of its availability to the operator or tenant; and, in response to determining the state associated with the service feature, one of providing or restricting access by the particular operator or tenant thereof to the particular service feature.

For example, as illustrated in FIG. 22, in accordance with an embodiment, and from the perspective of a client device 802, the process can include, at 803, receiving a request to perform an action associated with a service feature of a particular service (e.g., displaying a console interface).

At 804, a console plugin associated with a particular service can be initiated.

At 805, the process includes communicating with a feature management service to determine the availability of a service feature of the particular service.

At 806, the process includes receiving an availability state of the service feature from the feature management service.

Depending on the information received from the feature management service as to the state of the feature being either enabled (available), or disabled (unavailable), then the process proceeds, at 808, to allow the action associated with the service feature to be performed (e.g., to display the user interface element associated with the service feature); or alternatively, at 810, to not allow the action associated with the service feature (e.g., by disabling/hiding the user interface element associated with the service feature).

As illustrated in FIG. 22, in accordance with an embodiment, additional states that can be associated with service features or behaviors can include, for example, deprecated, or retired. For example, in the case of a deprecated service, the associated user interface element may be displayed in the console, but certain workflow operations may be disabled; while in the case of a retired service, the associated user interface element may be disabled/hidden, such that a user cannot see the feature in the console and cannot access the APIs associated with the service.

In accordance with an embodiment, the service control policies can be defined by a policy language which allows definition of (a) a service, (b) one or more service features associated with the service, and (c) one or more policies that enable or disable access to the service features. An example of the use of a policy language is described in further detail below.

In accordance with an embodiment, the feature management service determines in real time the state associated with the service feature based on the service control policies associated with the service, and an indication of a requesting operator or user.

In accordance with an embodiment, the service control policies are managed within a hierarchy of service control policies arranged as multiple levels, wherein at each level within the hierarchy of service control policies only the service features that have been made available by a higher-level entity can be controlled.

In accordance with an embodiment, the feature management service determines the state associated with the service feature by assessing a hierarchy of service control policies and relationships between the service control policies, including, within the hierarchy of service control policies, a first or higher-level of service control policies that defines a set of service features for which availability or access can be controlled by a second or lower-level of service control policies, and wherein the second or lower-level of service control policies control access to the set of service features in response to a request to access the service features.

In accordance with an embodiment, the hierarchy of service control policies includes, at the first or higher-level, one or more cloud infrastructure provider policies associated with a particular service feature, and, at the second or lower-level, one or more realm operator policies associated with the particular service feature that determine access by the operators to its tenants or users thereof.

In accordance with an embodiment, the hierarchy of service control policies includes the first or higher-level of service control policies and the second or lower-level of service control policies; wherein a service control policy provided at the first or higher-level, that defines availability or access to a particular service, allows a service control policy provided at the second or lower-level to control access to a subset of service features associated with the particular service.

In accordance with an embodiment, the first or higher-level of service control policies are cloud infrastructure provider policies associated with a particular service and associated service features, and the second or lower-level of service control policies are realm operator policies associated with the particular service and associated service features and are used to control access by tenants to the subset of service features.

In accordance with an embodiment, the management user interface or console associated with managing a service provides an adaptive user experience based on assessing the service control policy, including that console interface elements can be removed or otherwise indicated based on a feature unavailability, as determined by the service control policy.

In accordance with an embodiment, an operator can create and deploy a service control policy, to restrict the availability of services/features defined by the service control policy across an operator realm (e.g., a PLC realm).

In accordance with an embodiment, the process comprises receiving, by a feature management service, a request to determine an availability state of a service feature of a service to a lower-level of an operator hierarchy; and identifying a set of service control policies, wherein the set of service control policies comprises (a) a first subset of service control policies that are configured from an intermediate-level of the operator hierarchy and (b) a second subset of service control policies that are configured from a higher-level of the operator hierarchy, wherein the lower-level is directly below the intermediate-level in the operator hierarchy, and the intermediate-level is directly below the higher-level in the operator hierarchy

In accordance with an embodiment, the process further comprises determining that the first subset of service control policies are configured from the intermediate-level of the operator hierarchy that is directly above the lower-level of the operator hierarchy; evaluating one or more of the first subset of service control policies to determine the availability state of the service feature of the service to the lower-level of the operator hierarchy; and performing one or more of enforcing a behavior responsive to a call made to the service feature from the lower-level of the operator hierarchy based on the availability state of the service feature to the lower-level of the operator hierarchy; and/or causing display or hiding of a console plugin corresponding to the service feature within a console for the lower-level of the operator hierarchy based on the availability state of the service feature to the lower-level of the operator hierarchy.

In accordance with an embodiment, the set of possible values for the availability state comprises available and unavailable; the behavior responsive to the call made to the service feature from the lower-level of the operator hierarchy comprises refraining from prohibiting the call to be made if the availability state is available; the behavior responsive to the call made to the service feature from the lower-level of the operator hierarchy comprises prohibiting the call from being made if the availability state is unavailable.

In accordance with an embodiment, the call made to the service feature is allowed if at least (a) the feature management service refrains from prohibiting the call based on the availability state being available; and (b) an identity service allows access to the service feature based on one or more access policies.

In accordance with an embodiment, at least one of the set of service control policies is directed to the service feature, and the access policies cannot be directed to any service feature of any service.

In accordance with an embodiment, the set of possible values for the availability state further comprises deprecated and retired; the behavior responsive to the call made to the service feature from the lower-level of the operator hierarchy comprises displaying a blank indicator if the availability state is deprecated; the behavior responsive to the call made to the service feature from the lower-level of the operator hierarchy comprises displaying a blank indicator if the availability state is retired.

In accordance with an embodiment, the causing the display or hiding of the console plugin corresponding to the service feature within the console for the lower-level of the operator hierarchy based on the availability state of the service feature to the lower-level of the operator hierarchy comprises transmitting the availability state of the service feature to the console, wherein the console displays or hides the console plugin based on the availability state of the service feature.

In accordance with an embodiment, the evaluating the one or more of the first subset of service control policies to determine the availability state of the service feature of the service to the lower-level of the operator hierarchy comprises determining that the availability state is unavailable if at least one of the first subset of service control policies indicates disabling the service feature to the lower-level of the operator hierarchy.

In accordance with an embodiment, the evaluating the one or more of the first subset of service control policies to determine the availability state of the service feature of the service to the lower-level of the operator hierarchy comprises determining that the availability state is unavailable if none of the first subset of service control policies indicates enabling the service feature to the lower-level of the operator hierarchy.

In accordance with an embodiment, the evaluating the one or more of the first subset of service control policies to determine the availability state of the service feature of the service to the lower-level of the operator hierarchy comprises determining that the availability state is available if none of the first subset of service control policies indicates disabling the service feature to the lower-level of the operator hierarchy and at least one of the first subset of service control policies indicates enabling the service feature to the lower-level of the operator hierarchy.

In accordance with an embodiment, the service or service feature is accessed at an endpoint of an internal API gateway.

In accordance with an embodiment, the lower-level of the operator hierarchy comprises a customer; the intermediate-level of the operator hierarchy comprises a tenant; and the higher-level of the operator hierarchy comprises a cloud service provider.

In accordance with an embodiment, the lower-level of the operator hierarchy comprises a child tenancy; the intermediate-level of the operator hierarchy comprises a parent tenancy; and the higher-level of the operator hierarchy comprises a cloud service provider.

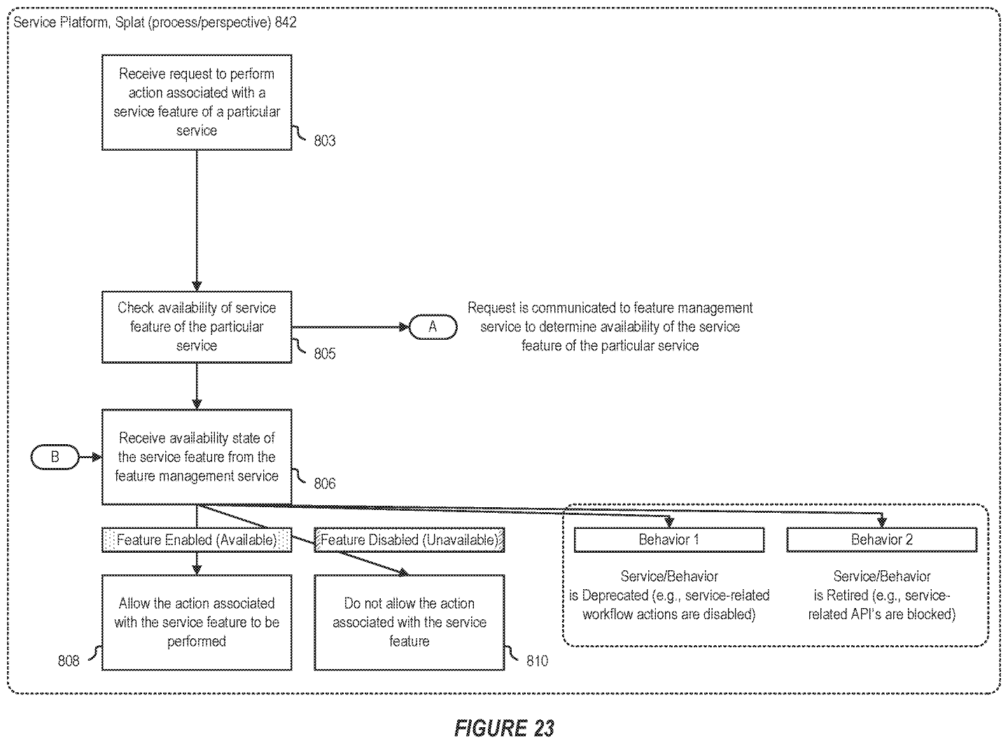

FIG. 23 illustrates a process of using service control policies to enable or disable availability or access to service features, from a perspective of a service platform, in accordance with an embodiment.

As illustrated in FIG. 23, in accordance with an embodiment, and from the perspective of a service platform 842, the process can operates as generally described above, for example to receiving a request to perform an action associated with a service feature of a particular service; communicating with a feature management service to determine the availability of a service feature of the particular service; and depending on the information received from the feature management service as to the state of the feature being either enabled (available), or disabled (unavailable), either allowing the action associated with the service feature to be performed (e.g., displaying a user interface element corresponding to the service feature within a console); or alternatively, not allowing the action associated with the service feature (e.g. disabling or hiding the user interface element corresponding to the service feature).

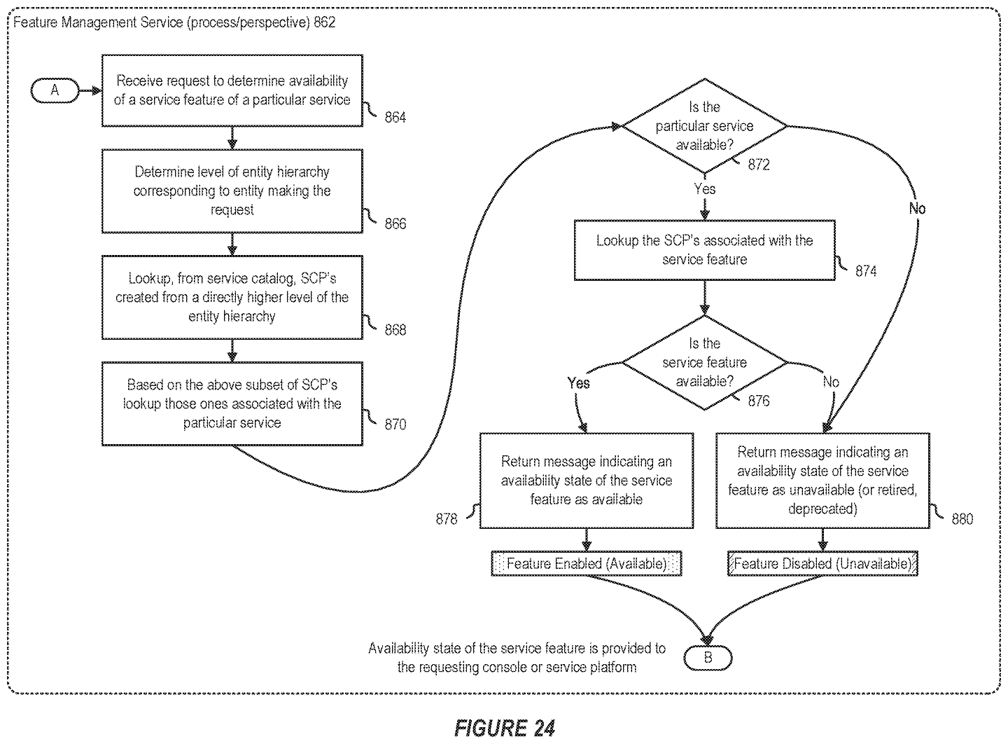

FIG. 24 illustrates a process of using service control policies to enable or disable availability or access to service features, from a perspective of a feature management service, in accordance with an embodiment.

As illustrated in FIG. 24, in accordance with an embodiment, and from the perspective of a feature management service 862, the process can include, at 864, receiving a request to determine the availability of a service feature of a particular service (as illustrated at (A) in FIGS. 22-23 described above); at 866, determining a level of entity hierarchy corresponding to the entity making the request; at 868, performing a lookup, from the service catalog, for service control policies created from a directly higher-level of the entity hierarchy; and, at 870, based on the above subset of service control policies, performing a lookup for those associated with the particular service.

At 872, a determination is made as to whether the particular service is available. If so then the process proceeds, at 874, to lookup the service control policies associated with the service feature.

At 876, a determination is made as to whether the service feature is available. If so then the process proceeds, at 878, to return a message indicating an availability state of the service feature as enabled or available.

Otherwise at 880, a return message is provided indicating an availability state of the service feature as disabled unavailable (or retired, deprecated). In accordance with an embodiment, the availability state of the service feature is provided to the requesting console or service platform (as illustrated at (B) in FIGS. 22-23 described above).

### User Interface

In accordance with an embodiment, the system can include a management user interface or console associated with managing a service provides an adaptive user experience based on assessing the service control policies associated with a particular service or service feature. For example, console interface elements can be removed or greyed-out based on a feature unavailability, as determined by the service control policy. The console user interface allows different operators to view the current state of services and service features, from their perspective or in accordance with their permission level.

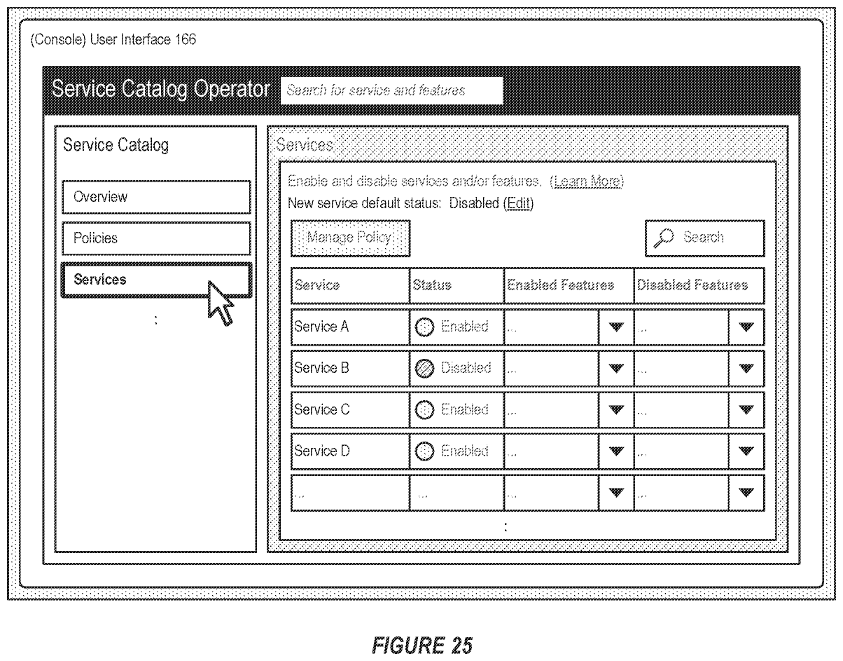

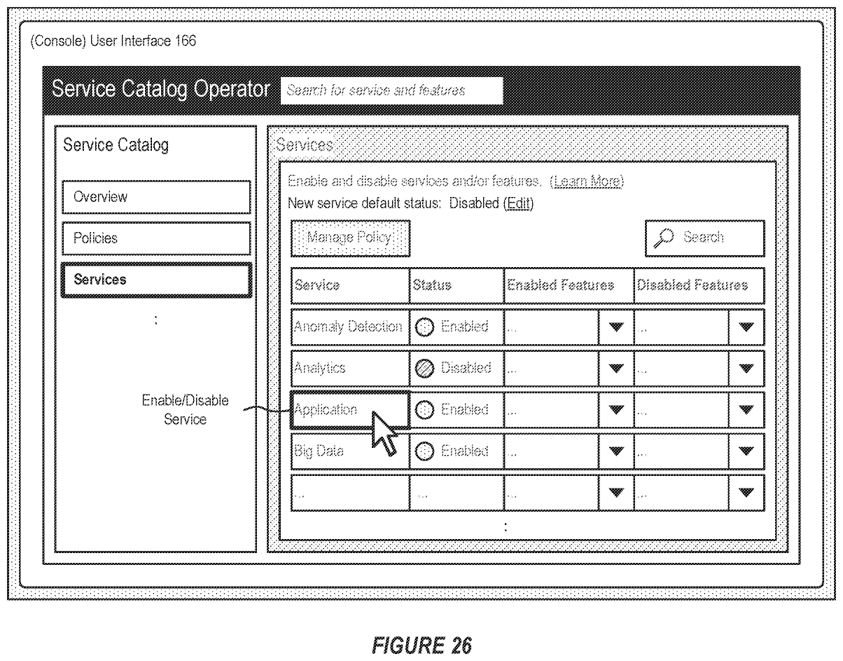

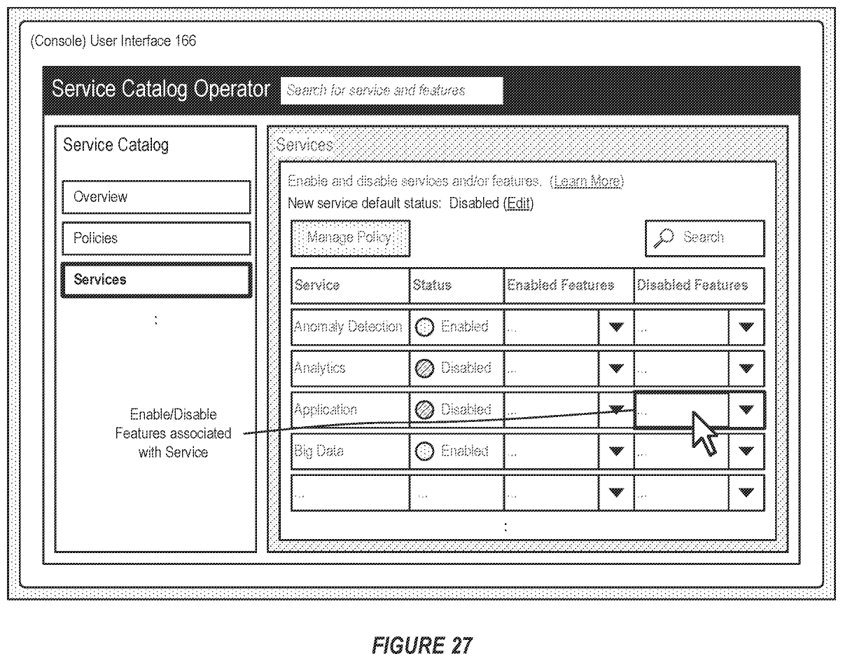

FIGS. 25-27 illustrate an example user interface for managing the use of service control policies within a cloud infrastructure environment, in accordance with an embodiment.

As illustrated in FIGS. 25-27, in accordance with an embodiment, the console user interface allows a user to manage polices, including select services, determine their status (e.g., as enabled or disabled) and enable or disable particular features associated therewith.

In accordance with an embodiment, the options available to a user (e.g., a cloud infrastructure provider operator, a realm operator, or an end user or customer) in defining availability or access to the service features will generally match the possible filtering criteria present in the policy language, for example: specific tenancy, wherein the operator should be able to see the feature state from the point-of-view of a specific tenancy; and regionality, since multiple teams will have to handle the same dimensions the console user interface can provide a unified way of handling them to make it consistent for the operators.

### Service Control Policy Language

In accordance with an embodiment, the service control policies can be defined by a policy language which allows definition of (a) a service, (b) one or more service features associated with the service, and (c) one or more policies that enable or disable access to the service features. Operators (e.g., a cloud infrastructure provider, or a realm operator) can create any number of service control policies, with any number of policy statements in each policy.

In accordance with an embodiment, an example policy syntax can be expressed as:

enable|disable
[all| #service-name]
[feature all | #feature-name]
[where request.tenancyID =/in #tenancy_list]
[request.region =/in #region-name]

Wherein the various items included within a service control policy, or associated rule that implements the service control policy, can include, for example:

| Item | Details |
|---|---|
| enable \| disable | The action the rule is implementing. |
| | enable—makes feature available |
| | to lower-levels. |
| | disable—makes feature unavailable |
| | to lower-levels. |
| service #service-name# | The service the rule applies to. |
| feature all \| #feature-name# | The feature the rule applies to; use |
| | all to target all the features in the service. |
| where #filters# | Rule filters. |

In accordance with an embodiment, when a request to access a service or feature is processed according to a service control policy, the request context can be populated by the caller with various details such as, for example a tenant ID, or region.

The above example is provided for the purposes of illustrating the teachings herein; and is not intended to be exhaustive or to limit the scope of protection to the precise forms disclosed; in accordance with other embodiments other types of service control policy languages and syntaxes can be used to define services, service features, and service control policies associated therewith.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A method for controlling access to service features, comprising:
providing, within a cloud infrastructure environment, a plurality of services for use by operators and tenants or users thereof;
providing, within a service control repository, a plurality of service control policies (SCPs) that define access to the services and service features;
determining, by a feature management service, in response to a request for access by a particular operator or tenant thereof to a particular service feature, by assessing the service control policies, a state associated with the service feature, indicative of its availability to the operator or tenant; and
in response to determining the state associated with the service feature, one of providing or restricting access by the particular operator or tenant thereof to the particular service feature.

2. The method of claim 1, wherein the service control policies are defined by a policy language which allows definition of (a) a service, (b) one or more service features associated with the service, and (c) one or more policies that enable or disable access to the service features.

3. The method of claim 1, wherein the feature management service determines in real time the state associated with the service feature based on the service control policies associated with the service, and an indication of a requesting operator or user.

4. The method of claim 1, wherein the service control policies are managed within a hierarchy of entities defining the service control policies arranged as multiple levels, wherein at each level within the hierarchy of entities defining the service control policies only the service features that have been made available by a higher-level entity can be controlled.

5. The method of claim 1, wherein the feature management service determines the state associated with the service feature by assessing a hierarchy of entities defining the service control policies and relationships between the service control policies, including, within the hierarchy of entities defining the service control policies, a first or higher-level of service control policies that defines a set of service features for which availability or access can be controlled by a second or lower-level of service control policies, and wherein the second or lower-level of service control policies control access to the set of service features in response to a request to access the service features.

6. The method of claim 5, wherein the hierarchy of entities defining the service control policies includes at the first or higher-level one or more cloud infrastructure provider policies associated with a particular service feature, and at the second or lower-level one or more realm operator policies associated with the particular service feature that determine access by the operators to its tenants or users thereof.

7. The method of claim 5, wherein the hierarchy of entities defining the service control policies includes the first or higher-level of service control policies and the second or lower-level of service control policies, and:
wherein a service control policy provided at the first or higher-level, that defines availability or access to a particular service, allows a service control policy provided at the second or lower-level to control access to a subset of service features associated with the particular service.

8. The method of claim 7, wherein the first or higher-level of service control policies are cloud infrastructure provider policies associated with a particular service and associated service features, and the second or lower-level of service control policies are realm operator policies associated with the particular service and associated service features and are used to control access by tenants to the subset of service features.

9. The method of claim 1, wherein a management user interface or console associated with managing a service provides an adaptive user experience based on assessing the service control policy, including that console interface elements can be removed or otherwise indicated based on a feature unavailability, as determined by the service control policy.

10. The method of claim 1, wherein an operator can create and deploy a service control policy, to restrict the availability of services/features defined by the service control policy across an operator realm.

11. A method, comprising:
receiving, by a feature management service, a request to determine an availability state of a service feature of a service to a lower-level of an operator hierarchy;
identifying, by the feature management service, a set of service control policies (SCPs), wherein the set of service control policies comprises (a) a first subset of service control policies that are configured from an intermediate-level of the operator hierarchy and (b) a second subset of service control policies that are configured from a higher-level of the operator hierarchy, wherein the lower-level is directly below the intermediate-level in the operator hierarchy, and the intermediate-level is directly below the higher-level in the operator hierarchy;
determining, by the feature management service, that the first subset of service control policies are configured from the intermediate-level of the operator hierarchy that is directly above the lower-level of the operator hierarchy;
evaluating, by the feature management service, one or more of the first subset of service control policies to determine the availability state of the service feature of the service to the lower-level of the operator hierarchy;
performing one or more of:
enforcing, by the feature management service, a behavior responsive to a call made to the service feature from the lower-level of the operator hierarchy based on the availability state of the service feature to the lower-level of the operator hierarchy; and/or
causing, by the feature management service, display or hiding of a console plugin corresponding to the service feature within a console for the lower-level of the operator hierarchy based on the availability state of the service feature to the lower-level of the operator hierarchy.

12. The method of claim 11, wherein:
a set of possible values for the availability state comprises available and unavailable;
the behavior responsive to the call made to the service feature from the lower-level of the operator hierarchy comprises refraining from prohibiting the call to be made if the availability state is available;
the behavior responsive to the call made to the service feature from the lower-level of the operator hierarchy comprises prohibiting the call from being made if the availability state is unavailable.

13. The method of claim 12, wherein the call made to the service feature is allowed if at least (a) the feature management service refrains from prohibiting the call based on the availability state being available and (b) an identity service allows access to the service feature based on one or more access policies.

14. The method of claim 13, wherein at least one of the set of service control policies is directed to the service feature, and the access policies cannot be directed to any service feature of any service.

15. The method of claim 12, wherein:
the set of possible values for the availability state further comprises deprecated and retired;
the behavior responsive to the call made to the service feature from the lower-level of the operator hierarchy comprises displaying a blank indicator if the availability state is deprecated;
the behavior responsive to the call made to the service feature from the lower-level of the operator hierarchy comprises displaying a blank indicator if the availability state is retired.

16. The method of claim 11, wherein causing, by the feature management service, display or hiding of the console plugin corresponding to the service feature within the console for the lower-level of the operator hierarchy based on the availability state of the service feature to the lower-level of the operator hierarchy comprises:
transmitting the availability state of the service feature to the console, wherein the console displays or hides the console plugin based on the availability state of the service feature.

17. The method of claim 11, wherein evaluating, by the feature management service, the one or more of the first subset of service control policies to determine the availability state of the service feature of the service to the lower-level of the operator hierarchy comprises:
determining that the availability state is unavailable if at least one of the first subset of service control policies indicates disabling the service feature to the lower-level of the operator hierarchy.

18. The method of claim 11, wherein evaluating, by the feature management service, the one or more of the first subset of service control policies to determine the availability state of the service feature of the service to the lower-level of the operator hierarchy comprises:
determining that the availability state is unavailable if none of the first subset of service control policies indicates enabling the service feature to the lower-level of the operator hierarchy.

19. The method of claim 11, wherein evaluating, by the feature management service, the one or more of the first subset of service control policies to determine the availability state of the service feature of the service to the lower-level of the operator hierarchy comprises:
determining that the availability state is available if none of the first subset of service control policies indicates disabling the service feature to the lower-level of the operator hierarchy and at least one of the first subset of service control policies indicates enabling the service feature to the lower-level of the operator hierarchy.

20. The method of claim 11, wherein the service or service feature is accessed at an endpoint of an internal API gateway.

21. The method of claim 11, wherein:
the lower-level of the operator hierarchy comprises a customer;
the intermediate-level of the operator hierarchy comprises a tenant;
the higher-level of the operator hierarchy comprises a cloud service provider.

22. The method of claim 11, wherein:
the lower-level of the operator hierarchy comprises a child tenancy;
the intermediate-level of the operator hierarchy comprises a parent tenancy;
the higher-level of the operator hierarchy comprises a cloud service provider.

23. A method, comprising:
receiving, by a feature management service, a request to determine an availability state of a service feature of a service to an intermediate-level of an operator hierarchy;
identifying, by the feature management service, a set of service control policies (SCPs) that are configured from a higher-level of the operator hierarchy, wherein the intermediate-level is directly below the higher-level in the operator hierarchy;
evaluating, by the feature management service, one or more of the set of service control policies to determine the availability state of the service feature of the service to the intermediate-level of the operator hierarchy;
allowing or prohibiting, by the feature management service, one or more service control policies to be configured, from the intermediate-level of the operator hierarchy, for controlling a second availability state of the service feature to a lower-level of the operator hierarchy, based on the availability state of the service feature to the intermediate-level of the operator hierarchy, wherein the lower-level is directly below the intermediate-level in the operator hierarchy.

24. The method of claim 23 comprising:
wherein the availability state of the service feature to the first level of the operator hierarchy is available;
wherein the feature management service allows one or more control policies (SCPs) to be configured for the service feature from the intermediate-level of the operator hierarchy for the lower-level of the operator hierarchy;
further comprising:
receiving, by the feature management service, configuration of a second set of one or more service control policies from the intermediate-level of the operator hierarchy for the lower-level of the operator hierarchy;
evaluating, by the feature management service, one or more of the second set of service control policies to determine a second availability state of the service feature of the service to the lower-level of operator hierarchy;
enforcing, by the feature management service, a behavior responsive to a call made to the service feature from the lower-level of the operator hierarchy based on the second availability state of the service feature to the lower-level of the operator hierarchy.

25. The method of claim 23, wherein the service control policies are defined by a policy language which allows definition of (a) a service, (b) one or more service features associated with the service, and (c) one or more policies that enable or disable access to the service features.

26. The method of claim 23, wherein a feature management service determines in real time the state associated with the service feature based on the service control policies associated with the service, and an indication of a requesting operator or user.

27. The method of claim 23, wherein the service control policies are managed within a hierarchy of entities defining the service control policies arranged as multiple levels, wherein at each level within the hierarchy of entities defining the service control policies only the service features that have been made available by a higher-level entity can be controlled.

28. The method of claim 23, wherein a feature management service determines the state associated with the service feature by assessing a hierarchy of entities defining the service control policies and relationships between the service control policies, including, within the hierarchy of entities defining the service control policies, a first or higher-level of service control policies that defines a set of service features for which availability or access can be controlled by a second or lower-level of service control policies, and wherein the second or lower-level of service control policies control access to the set of service features in response to a request to access the service features.

29. The method of claim 28, wherein the hierarchy of entities defining the service control policies includes at the first or higher-level one or more cloud infrastructure provider policies associated with a particular service feature, and at the second or lower-level one or more realm operator policies associated with the particular service feature that determine access by the operators to its tenants or users thereof.

30. The method of claim 28, wherein the hierarchy of entities defining the service control policies includes the first or higher-level of service control policies and the second or lower-level of service control policies, and:
wherein a service control policy provided at the first or higher-level, that defines availability or access to a particular service, allows a service control policy provided at the second or lower-level to control access to a subset of service features associated with the particular service.

31. The method of claim 30, wherein the first or higher-level of service control policies are cloud infrastructure provider policies associated with a particular service and associated service features, and the second or lower-level of service control policies are realm operator policies associated with the particular service and associated service features and are used to control access by tenants to the subset of service features.

32. The method of claim 23, wherein a management user interface or console associated with managing a service provides an adaptive user experience based on assessing the service control policy, including that console interface elements can be removed or otherwise indicated based on a feature unavailability, as determined by the service control policy.

33. The method of claim 1, wherein an operator can create and deploy a service control policy, to restrict the availability of services/features defined by the service control policy across an operator realm.

34. A method, comprising:
receiving, by a feature management service, a request to determine an availability state of a service feature of a service;
identifying, by the feature management service, a set of service control policies (SCPs), wherein the set of service control policies comprises (a) a first subset of service control policies that are respectively directed to a plurality of services, and (b) a second subset of service control policies that are respectively directed to a plurality of service features, wherein the plurality of services are respectively associated with the plurality of service features;
determining, by the feature management service, that a relevant subset of the set of service control policies, wherein the relevant subset of service control policies comprises one or more of: (a) a first service control policy (SCP) from the first subset of service control policies that is directed to the service, or (b) a second SCP from the second subset of service control policies that is directed to the service feature;
evaluating, by the feature management service, one or more of the relevant subset of service control policies to determine the availability state of the service feature of the service;
performing one or more of:
enforcing, by the feature management service, a behavior responsive to a call made to the service feature based on the availability state of the service feature;
causing, by the feature management service, display or hiding of a console plugin corresponding to the service feature within a console based on the availability state of the service feature.

35. The method of claim 34, wherein the service control policies are defined by a policy language which allows definition of (a) a service, (b) one or more service features associated with the service, and (c) one or more policies that enable or disable access to the service features.

36. The method of claim 34, wherein a feature management service determines in real time the state associated with the service feature based on the service control policies associated with the service, and an indication of a requesting operator or user.

37. The method of claim 34, wherein the service control policies are managed within a hierarchy of entities defining the service control policies arranged as multiple levels, wherein at each level within the hierarchy of entities defining the service control policies only the service features that have been made available by a higher-level entity can be controlled.

38. The method of claim 34, wherein a feature management service determines the state associated with the service feature by assessing a hierarchy of entities defining the service control policies and relationships between the service control policies, including, within the hierarchy of entities defining the service control policies, a first or higher-level of service control policies that defines a set of service features for which availability or access can be controlled by a second or lower-level of service control policies, and wherein the second or lower-level of service control policies control access to the set of service features in response to a request to access the service features.

39. The method of claim 38, wherein the hierarchy of entities defining the service control policies includes at the first or higher-level one or more cloud infrastructure provider policies associated with a particular service feature, and at the second or lower-level one or more realm operator policies associated with the particular service feature that determine access by the operators to its tenants or users thereof.

40. The method of claim 38, wherein the hierarchy of entities defining the service control policies includes the first or higher-level of service control policies and the second or lower-level of service control policies, and:
wherein a service control policy provided at the first or higher-level, that defines availability or access to a particular service, allows a service control policy provided at the second or lower-level to control access to a subset of service features associated with the particular service.

41. The method of claim 40, wherein the first or higher-level of service control policies are cloud infrastructure provider policies associated with a particular service and associated service features, and the second or lower-level of service control policies are realm operator policies associated with the particular service and associated service features and are used to control access by tenants to the subset of service features.

42. The method of claim 34, wherein a management user interface or console associated with managing a service provides an adaptive user experience based on assessing the service control policy, including that console interface elements can be removed or otherwise indicated based on a feature unavailability, as determined by the service control policy.

43. The method of claim 34, wherein an operator can create and deploy a service control policy, to restrict the availability of services/features defined by the service control policy across an operator realm.

44. A system comprising:
a computer comprising a processor device and a non-transitory memory operatively coupled with the processor device, wherein the computer performs a method comprising:
providing, within a cloud infrastructure environment, a plurality of services for use by operators and tenants or users thereof;
providing, within a service control repository, a plurality of service control policies (SCPs) that define access to the services and service features;
determining, by a feature management service, in response to a request for access by a particular operator or tenant thereof to a particular service feature, by assessing the service control policies to determine a state associated with the service feature, indicative of its availability to the operator or tenant; and
in response to determining the state associated with the service feature, one of providing or restricting access by the particular operator or tenant thereof to the particular service feature.

45. A non-transitory computer readable storage medium having instructions thereon, which when performed in a computer system including a processor cause the computer to perform a method comprising:
providing, within a cloud infrastructure environment, a plurality of services for use by operators and tenants or users thereof;
providing, within a service control repository, a plurality of service control policies (SCPs) that define access to the services and service features;
determining, by a feature management service, in response to a request for access by a particular operator or tenant thereof to a particular service feature, by assessing the service control policies to determine a state associated with the service feature, indicative of its availability to the operator or tenant; and
in response to determining the state associated with the service feature, one of providing or restricting access by the particular operator or tenant thereof to the particular service feature.
